(19) United States
(12) Patent Application Publication
(10) Pub. No.: US 2017/0221379 A1
(43) Pub. Date: Aug. 3, 2017

(54) INFORMATION TERMINAL, MOTION EVALUATING SYSTEM, MOTION EVALUATING METHOD, AND RECORDING MEDIUM

(71) Applicant: Seiko Epson Corporation, Shinjuku-ku (JP)

(72) Inventor: Kenji Onda, Azumino-shi (JP)

(21) Appl. No.: 15/421,940

(22) Filed: Feb. 1, 2017

(30) Foreign Application Priority Data
Feb. 2, 2016 (JP) 2016-017839

(51) Int. Cl. G09B 19/00; G09B 5/06; H04N 5/265; H04N 9/64; H04N 5/775; H04N 7/18

(52) U.S. Cl. CPC G09B 19/0015; H04N 5/775; H04N 7/183; H04N 5/265; H04N 9/64; G09B 5/06

(57) ABSTRACT

An information terminal includes a reception processing section configured to receive, via a network, sensing data of a motion of a teacher and moving image data of the motion of the teacher associated with the sensing data of the motion of the teacher, a presentation processing section configured to present the moving image data of the motion of the teacher to a user, an evaluating section configured to perform, when the moving image data of the motion of the teacher is presented, an evaluation of a motion of the user using sensing data of the motion of the user and the sensing data of the motion of the teacher, and a notification processing section configured to notify the user of a result of the evaluation when the moving image data is presented.

### CROSS-REFERENCE TO RELATED APPLICATIONS

The entire disclosure of Japanese Patent Application No. 2016-017839, filed Feb. 2, 2016 is expressly incorporated by reference herein.

### BACKGROUND

1. Technical Field

The present invention relates to an information terminal, a motion evaluating system, a motion evaluating method, and a recording medium.

2. Related Art

JP-A-2011-87794 (Patent Literature 1) discloses a system that calculates a coincidence state or a deviation state (synchronism) of movements for each of body parts of users and performs a feedback output in gymnastics or a dance performed in a group. The system feeds back a basic exercise rhythm to a user as a tactile stimulus and sets the tactile stimulus larger for a user having larger deviation of a movement. Patent Literature 1 mentions that the system may enable the user to review a difference between a template registered in advance and the rhythm of the user.

However, the movement of the user is not always considered to be set to an ideal movement simply by matching rhythms between the user and the other users or the template. According to the feedback of the system, it may be possible to notify the user of deviation of timing. However, it is considered difficult to notify the user of spatial deviation.

### SUMMARY

An advantage of some aspects of the invention is to provide an information terminal, a motion evaluating system, and a recording medium effective for personal practice for a user to learn a motion.

The invention can be implemented as the following forms or application examples.

### Application Example 1

An information terminal according to this application example includes: a reception processing section configured to receive, via a network, sensing data of a motion of a teacher and moving image data of the motion of the teacher associated with the sensing data of the motion of the teacher; a presentation processing section configured to present the moving image data of the motion of the teacher to a user; an evaluating section configured to perform, when the moving image data of the motion of the teacher is presented, an evaluation of a motion of the user using sensing data of the motion of the user and the sensing data of the motion of the teacher; and a notification processing section configured to notify the user of a result of the evaluation when the moving image data is presented.

The evaluating section performs, during reproduction of the moving image data of the motion of the teacher, the evaluation of the motion of the user using the sensing data of the motion of the user and the sensing data of the motion of the teacher. The notification processing section notifies the user of the result of the evaluation during the presentation of the moving image data of the motion of the teacher. Therefore, the information terminal according to this application example can urge, by presenting the motion of the teacher to the user, the user to perform a motion same as the motion of the teacher and notify, during the presentation of the motion of the teacher, the user of the result of the evaluation performed using the motion of the teacher and the motion of the user.

Therefore, the user can practice a motion while visually checking the motion of the teacher and recognize, during the motion, an evaluation result of the motion of the user based on the motion of the teacher. Therefore, the user can easily grasp, during the practice, which portion of the motion of the user should be improved to bring the motion of the user close to the motion of the teacher. Therefore, the information terminal according to this application example is effective for personal practice for the user to learn the motion of the teacher.

### Application Example 2

In the information terminal according to the application example, the sensing data of the motion of the user may be generated using two or more sensors worn on parts of a body of the user different from one another.

The information terminal uses the two or more sensors worn on the parts of the body of the user different from one another. Therefore, for example, it is possible to reflect, on the sensing data of the user, movements of a plurality of parts of the user such as movements of the joints of the user, movements of a positional relation of the hands and the feet of the user, and movements of both the hands of the user.

### Application Example 3

In the information terminal according to the application example, the sensing data of the motion of the teacher may be generated using two or more sensors worn on parts of a body of the teacher different from one another.

The information terminal uses the two or more sensors worn on the parts of the body of the teacher different from one another. Therefore, for example, it is possible to reflect, on the sensing data of the teacher, movements of a plurality of parts of the teacher such as movements of the joints of the teacher, movements of a positional relation of the hands and the feet of the teacher, and movements of both the hands of the teacher.

### Application Example 4

The information terminal according to the application example may further include an image pickup section configured to acquire moving image data of the motion of the user. The presentation processing section may present the moving image data of the motion of the user together with the moving image data of the motion of the teacher.

Therefore, the user can practice a motion while visually comparing the motion of the teacher and the motion of the user.

### Application Example 5

In the information terminal according to the application example, the presentation processing section may present the moving image data of the motion of the teacher and the moving image data of the motion of the user side by side with each other or one on top of the other.

When the moving image data of the motion of the teacher and the moving image data of the motion of the user are presented side by side with each other, the user can visually compare and check the motion of the teacher and the motion of the user. On the other hand, when the moving image data of the motion of the teacher and the moving image data of the motion of the user are presented one on top of the other, the user can intuitively recognize deviation between the motion of the teacher and the motion of the user.

### Application Example 6

In the information terminal according to the application example, the moving image data of the motion of the user may include information concerning colors different from one another respectively corresponding to the two or more sensors worn on the user.

If the moving image data includes the information concerning the colors different from one another corresponding to the sensors in this way, the sensors, parts of the body of the user wearing the sensors, and the colors correspond to one another. Therefore, when the user views a moving image, the user can easily understand a correspondence relation between the motion of the user and the parts of the body in the moving image. Therefore, the user can more easily recognize the motion of the user than when the colors are not used.

### Application Example 7

In the information terminal according to the application example, the moving image data of the motion of the teacher may include information concerning colors different from one another respectively corresponding to the two or more sensors worn on the teacher.

If the moving image data includes the information concerning the colors different from one another corresponding to the sensors in this way, the sensors, parts of the body of the teacher wearing the sensors, and the colors correspond to one another. Therefore, when the user views a moving image, the user can easily understand a correspondence relation between the motion of the user and the parts of the body of the teacher in the moving image. Therefore, the user can more easily recognize the motion of the user than when the colors are not used.

### Application Example 8

The information terminal according to the application example may further include a transmitting section configured to transmit the sensing data of the motion of the user and the moving image data of the motion of the user in association with each other via the network.

Therefore, the user can store the sensing data and the moving image data of the motion of the user in a server in association with each other.

### Application Example 9

In the information terminal according to the application example, the teacher may be a user different from the user.

Therefore, the information terminal according to this application example is effective when a certain user desires to learn a motion same as a motion of another user. For example, the information terminal is effective when another user desires to imitate a motion of a user famous on the Internet.

### Application Example 10

In the information terminal according to the application example, information concerning sound may be added to the moving image data of the motion of the teacher.

Therefore, the user can check the information of the sound in addition to the motion of the teacher obtained from the moving image data. Therefore, the user can easily learn a motion than, for example, when the user uses the moving image data without the information concerning the sound.

### Application Example 11

In the information terminal according to the application example, the sensing data may include an output of at least one of an acceleration sensor and an angular velocity sensor.

Therefore, the information terminal can include, in the sensing data, for example, at least one of acceleration, speed, a position, a posture change, and a posture of the body of the teacher.

### Application Example 12

A motion evaluating system according to this application example includes: a sensor configured to sense a motion of a user; and an information terminal including: a reception processing section configured to receive, via a network, sensing data of a motion of a teacher and moving image data of the motion of the teacher associated with the sensing data of the motion of the teacher; a presentation processing section configured to present the moving image data of the motion of the teacher to the user; an evaluating section configured to perform, when the moving image data of the motion of the teacher is presented, an evaluation of a motion of the user using sensing data of the motion of the user generated using the sensor and the sensing data of the motion of the teacher; and a notification processing section configured to notify the user of a result of the evaluation when the moving image data is presented.

### Application Example 13

A motion evaluating method according to this application example includes: receiving, via a network, sensing data of a motion of a teacher and moving image data of the motion of the teacher associated with the sensing data of the motion of the teacher; presenting the moving image data of the motion of the teacher to a user; performing, when the moving image data of the motion of the teacher is presented, an evaluation of a motion of the user using sensing data of the motion of the user and the sensing data of the motion of the teacher; and notifying the user of a result of the evaluation when the moving image data is presented.

In the motion evaluating method according to this application example, the evaluation of the motion of the user is performed using the sensing data of the motion of the user and the sensing data of the motion of the teacher during reproduction of the moving image data of the motion of the teacher. The result of the evaluation is notified to the user during the presentation of the moving image data of the motion of the teacher. Therefore, in the motion evaluating method according to this application example, it is possible to urge, by presenting the motion of the teacher to the user, the user to perform a motion same as the motion of the teacher and notify, during the presentation of the motion of the teacher, the user of the result of the evaluation performed using the motion of the teacher and the motion of the user.

Therefore, the user can practice a motion while visually checking the motion of the teacher and recognize, during the motion, an evaluation result of the motion of the user based on the motion of the teacher. Therefore, the user can easily grasp, during the practice, which portion of the motion of the user should be improved to bring the motion of the user close to the motion of the teacher. Therefore, the motion evaluating method according to this application example is effective for personal practice for the user to learn the motion of the teacher.

### Application Example 14

A motion evaluating program according to this application example causes a computer to execute: receiving, via a network, sensing data of a motion of a teacher and moving image data of the motion of the teacher associated with the sensing data of the motion of the teacher; presenting the moving image data of the motion of the teacher to a user; performing, when the moving image data of the motion of the teacher is presented, an evaluation of a motion of the user using sensing data of the motion of the user and the sensing data of the motion of the teacher; and notifying the user of a result of the evaluation when the moving image data is presented.

The motion evaluating program according to this application example causes the computer to perform the evaluation of the motion of the user using the sensing data of the motion of the user and the sensing data of the motion of the teacher during reproduction of the moving image data of the motion of the teacher and notify the user of the result of the evaluation during the presentation of the moving image data of the motion of the teacher. Therefore, the motion evaluating program according to this application example can urge, by presenting the motion of the teacher to the user, the user to perform a motion same as the motion of the teacher and notify, during the presentation of the motion of the teacher, the user of the result of the evaluation performed using the motion of the teacher and the motion of the user.

Therefore, the user can practice a motion while visually checking the motion of the teacher and recognize, during the motion, an evaluation result of the motion of the user based on the motion of the teacher. Therefore, the user can easily grasp, during the practice, which portion of the motion of the user should be improved to bring the motion of the user close to the motion of the teacher. Therefore, the motion evaluating program according to this application example is effective for personal practice for the user to learn the motion of the teacher.

### Application Example 15

A recording medium according to this application example has recorded therein a motion evaluating program for causing a computer to execute: receiving, via a network, sensing data of a motion of a teacher and moving image data of the motion of the teacher associated with the sensing data of the motion of the teacher; presenting the moving image data of the motion of the teacher to a user; performing, when the moving image data of the motion of the teacher is presented, an evaluation of a motion of the user using sensing data of the motion of the user and the sensing data of the motion of the teacher; and notifying the user of a result of the evaluation when the moving image data is presented.

The computer can perform the evaluation of the motion of the user using the sensing data of the motion of the user and the sensing data of the motion of the teacher during reproduction of the moving image data of the motion of the teacher and notify the user of the result of the evaluation during the presentation of the moving image data of the motion of the teacher. Therefore, the computer can urge, by presenting the motion of the teacher to the user, the user to perform a motion same as the motion of the teacher and notify, during the presentation of the motion of the teacher, the user of the result of the evaluation performed using the motion of the teacher and the motion of the user.

Therefore, the user can practice a motion while visually checking the motion of the teacher and recognize, during the motion, an evaluation result of the motion of the user based on the motion of the teacher. Therefore, the user can easily grasp, during the practice, which portion of the motion of the user should be improved to bring the motion of the user close to the motion of the teacher. Therefore, the computer is effective for personal practice for the user to learn the motion of the teacher.

### BRIEF DESCRIPTION OF THE DRAWINGS

The invention will be described with reference to the accompanying drawings, wherein like numbers reference like elements.

FIG. 1 is a diagram showing a wearing example of sensor units.

FIG. 2 is a diagram showing a configuration example of a dance analyzing system.

FIG. 3 is a graph for comparing posture data of the waist of a teacher and posture data of the waist of a user concerning the same section of the same musical piece.

FIG. 4 is a graph for comparing posture data of the waist of the teacher and posture data of the waist of the user concerning another same section of the same musical piece.

FIG. 5 is a graph for comparing posture data of the waist of the teacher and posture data of the waist of the user concerning still another same section of the same musical piece.

FIG. 6 is a graph for comparing acceleration data of the waist of the teacher and acceleration data of the waists of three users concerning still another same section of the same musical piece.

FIG. 7 is an example of a selection screen including a tab for data selection, a tab for dance analysis, and a tab for after-feedback.

FIG. 8 is an example of a screen for instructing a user to take a predetermined pose.

FIG. 9 is an example of a screen for notifying the user of permission of a dance start.

FIG. 10 is an example of a screen displayed during reproduction of a musical piece in a dance analysis mode.

FIG. 11 is another example of the screen displayed during the reproduction of the musical piece in the dance analysis mode.

FIG. 12 is an example of a screen for displaying a synchronization ratio.

FIG. 13 is an example of a screen displayed during reproduction of a musical piece in an after-feedback mode.

FIG. 14 is a flowchart of an information terminal in a data selection mode.

FIG. 15 is a flowchart of a server that performs communication with the information terminal in the data selection mode.

FIG. 16 is a flowchart of the information terminal in the dance analysis mode.

FIG. 17 is a flowchart of the information terminal in the after-feedback mode.

### DESCRIPTION OF EXEMPLARY EMBODIMENTS

A preferred embodiment of the invention is explained in detail below with reference to the drawings. Note that the embodiment explained below does not unduly limit contents of the invention described in the appended claims. Not all of components explained below are always essential constituent elements of the invention.

A dance analyzing system that performs an analysis of a dance is explained below as an example.

### 1. Dance Analyzing System

### 1-1. Overview of the Dance Analyzing System

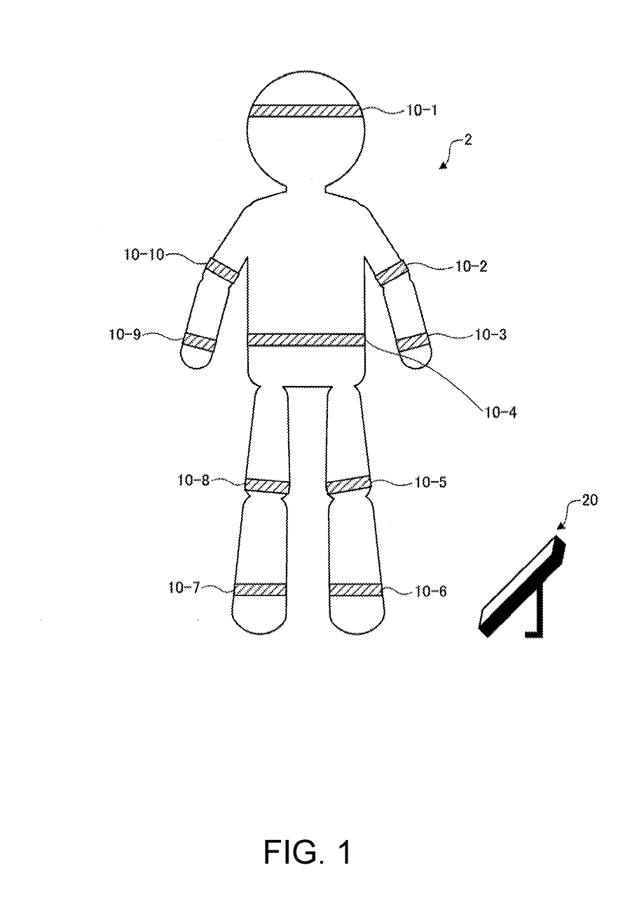

FIG. 1 is a diagram showing a configuration example of a dance analyzing system in this embodiment. As shown in FIG. 1, the dance analyzing system in this embodiment includes one or a plurality of sensor units 10 worn on the body of a user 2 and an information terminal 20 configured by a smartphone, a tablet PC (Personal Computer), or the like. Note that the information terminal 20 is an information terminal capable of performing information communication with a not-shown server via a not-shown network. The information terminal 20 may be configured by two devices such as a main body and an operation section (a controller). However, in the following explanation, it is assumed that the information terminal 20 is a standalone apparatus.

### 1-2. Wearing Fixtures of the Sensor Units

As shown in FIG. 1, the sensor units 10 are worn on the body of the user 2. In an example explained below, ten sensor units 10 are individually worn on ten parts of the body of the user 2 different from one another. The ten sensor units 10 are respectively (1) to (10) described below.

(1) A sensor unit 10-1 worn on the head of the user 2
(2) A sensor unit 10-2 worn on the left elbow of the user 2
(3) A sensor unit 10-3 worn on the left wrist of the user 2
(4) A sensor unit 10-4 worn on the waist of the user 2
(5) A sensor unit 10-5 worn on the left knee of the user 2
(6) A sensor unit 10-6 worn on the left ankle of the user 2
(7) A sensor unit 10-7 worn on the right ankle of the user 2
(8) A sensor unit 10-8 worn on the right knee of the user 2
(9) A sensor unit 10-9 worn on the right wrist of the user 2
(10) A sensor unit 10-10 worn on the right elbow of the user 2

The ten sensor units 10-1, 10-2, 10-3, 10-4, 10-5, 10-6, 10-7, 10-8, 10-9, and 10-10 have the same configuration. Therefore, in the following explanation, the sensor units 10-1, 10-2, 10-3, 10-4, 10-5, 10-6, 10-7, 10-8, 10-9, and 10-10 (an example of the two or more sensors or sensor units worn on parts different from one another) are respectively referred to as “sensor units 10” as appropriate. The ten sensor units 10 are respectively worn on the parts via wearing fixtures (e.g., belt-like or tape-like wearing fixtures).

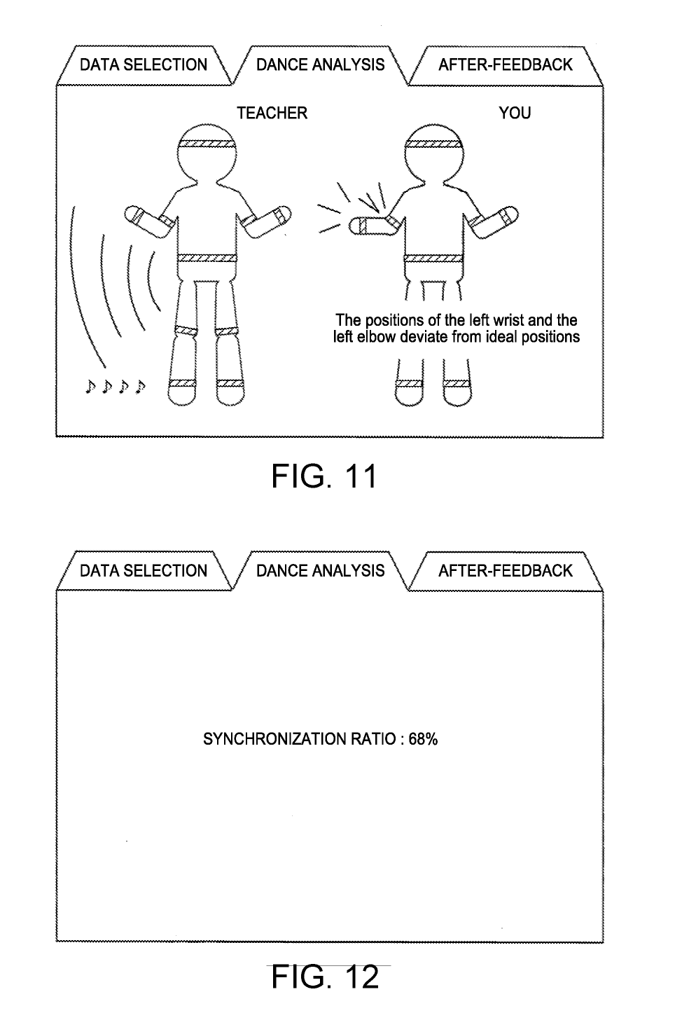

The wearing fixtures of the sensor units 10 are colored in predetermined colors such that the parts on which the sensor units 10 are worn are emphasized in moving images (FIGS. 10, 11, etc.) explained below. For example, colors different from one another are allocated to the wearing fixtures worn on parts different from one another such that parts of the user 2 are distinguished in the moving images (FIGS. 10, 11, etc.) explained below. For example, red is allocated to the wearing fixture worn on the head, blue is allocated to the wearing fixture worn on the left elbow, and green is allocated to the wearing fixture worn on the left wrist. A method of allocating the colors to the parts is determined in advance to facilitate comparison among users. Therefore, the wearing fixtures are configured, for example, as explained below as wearing fixtures exclusive for the parts.

A wearing fixture exclusive for the sensor unit 10-1 has a description indicating that the wearing fixture is a wearing fixture for the head. The wearing fixture is colored in a color for the head.

A wearing fixture exclusive for the sensor unit 10-2 has a description indicating that the wearing fixture is a wearing fixture for the left elbow. The wearing fixture is colored in a color for the left elbow.

A wearing fixture exclusive for the sensor unit 10-3 has a description indicating that the wearing fixture is a wearing fixture for the left wrist. The wearing fixture is colors in a color for the left wrist.

A wearing fixture exclusive for the sensor unit 10-4 has a description indicating that the wearing fixture is a wearing fixture for the waist. The wearing fixture is colored in a color for the waist.

A wearing fixture exclusive for the sensor unit 10-5 has a description indicating that the wearing fixture is a wearing fixture for the left knee. The wearing fixture is colored in a color for the left knee.

A wearing fixture exclusive for the sensor unit 10-6 has a description indicating that the wearing fixture is a wearing fixture for the left ankle. The wearing fixture is colored in a color for the left ankle.

A wearing fixture exclusive for the sensor unit 10-7 has a description indicating that the wearing fixture is a wearing fixture for the right ankle. The wearing fixture is colored in a color for the right ankle.

A wearing fixture exclusive for the sensor unit 10-8 has a description indicating that the wearing fixture is a wearing fixture for the right knee. The wearing fixture is colored in a color for the right knee.

A wearing fixture exclusive for the sensor unit 10-9 has a description indicating that the wearing fixture is a wearing fixture for the right wrist. The wearing fixture is colored in a color for the right wrist.

A wearing fixture exclusive for the sensor unit 10-10 has a description indicating that the wearing fixture is a wearing fixture for the right elbow. The wearing fixture is colored in a color for the right elbow.

Note that, although the colors different from one another are allocated to the wearing fixtures worn on the parts of the body different from one another, light emitting sections (light emitting diodes, etc.) that emit lights having colors different from one another to the sensor units 10 or the wearing fixtures worn on the parts different from one another may be provided. However, in order to avoid the light emitting sections from being hidden by the body of the user 2, it is desirable to provide two or more light emitting sections in one sensor unit.

Although the wearing fixtures of the sensor units 10 are colored, the sensor units 10 may be colored. That is, coloring the sensor units and coloring the wearing fixtures are respectively examples of coloring the sensor units 10.

Although the colors different from one another are allocated to the wearing fixtures worn on the parts of the body different from one another, the sensor units 10 worn on the parts different from one another may be colored in colors different from one another.

Therefore, user dance analysis data 243 explained below includes information concerning the colors different from one another respectively corresponding to the two or more sensors worn on the user 2.

Note that, in the example explained above, the parts on which the two or more sensors are worn are determined in advance. However, when parts on which the two or more sensors are worn are not determined in advance, data indicating a correspondence relation between the colors of the respective sensors and the parts on which then sensors are worn is added to the user dance analysis data 243. In that case, the user 2 only has to manually input the data indicating the correspondence relation to the information terminal 20.

In the example explained above, the user 2 wears the ten sensor units 10 on the ten parts. However, the user 2 does not have to wear any one or a plurality of sensor units 10. That is, when the number of the sensor units 10 owned by the user 2 is less than ten, the number of the sensor units 10 worn on the body of the user 2 may be less than ten. Depending on a proficiency level of the user 2, for example, the sensor unit 10 for the waist can be omitted. Depending on a type or the like of a dance, for example, the sensor units 10 for the feet can be omitted.

### 1-3. Configuration of the Sensor Unit

The configuration of each of the ten sensor units 10 is as explained below.

The sensor unit 10 includes at least one sensor. The sensor unit 10 includes, for example, a three-axis acceleration sensor, a three-axis gyro sensor (angular velocity sensor), and a communication section. The three-axis acceleration sensor repeatedly detects accelerations in three-axis (an x axis, a y axis, and a z axis) directions at a predetermined cycle. The three-axis angular velocity sensor repeatedly detects angular velocities in the three-axis (the x axis, the y axis, and the z axis) directions at the predetermined cycle. Note that the detection axes may be more than three axes.

The sensors only have to be sensors capable of measuring inertial amounts such as acceleration and angular velocity. The sensors may be, for example, inertial measurement units (IMU) capable of measuring acceleration and angular velocity.

The communication section of the sensor unit 10 transmits measurement data in time series (acceleration data in time series and angular velocity data in time series) acquired at the predetermined cycle to the information terminal 20 at the predetermined cycle. The measurement data including at least one of the acceleration data in time series and the angular velocity data in time series is an example of the sensing data.

Note that communication between the communication section of the sensor unit 10 and a communication section of the information terminal 20 is performed on the basis of a predetermined communication standard such as short-range wireless communication. For example, the communication section of the information terminal 20 transmits time information to the communication section of the sensor unit 10. The communication section of the sensor unit 10 transmits measurement data to the communication section of the information terminal 20 in synchronization with the time information. When transmitting the measurement data to the communication section of the information terminal 20, the communication section of the sensor unit 10 adds sensor identification information of the sensor unit 10 to the measurement data.

On the other hand, it is assumed that the user 2 inputs, in advance, sensor wearing position information indicating a part on which the sensor unit 10 is worn and sensor identification information of the sensor unit 10 to the information terminal 20 for each of the sensor units. Incidentally, the input of the sensor identification information is what is called “pairing” in general in the short-range wireless communication. After the input, in a storing section of the information terminal 20, respective kinds of sensor identification information of the ten sensor units 10 and respective kinds of sensor wearing position information of the ten sensor units 10 are stored in association with each other.

Therefore, the information terminal 20 is capable of recognizing, on the basis of the information stored in the storing section, a source of acquisition of measurement data received from a certain sensor unit 10 (i.e., a type of a part of the body). When the user 2 does not wear the sensor unit 10 for a portion of a part of the body, the information terminal 20 can recognize that the sensor unit 10 is not worn.

Note that the sensor unit 10 may include a signal processing section. When receiving acceleration data and angular velocity data (measurement data) respectively from the acceleration sensor and the angular velocity sensor of the sensor unit 10, the signal processing section of the sensor unit 10 adds time information to the measurement data and outputs the measurement data to the communication section of the sensor unit 10 as a format for communication.

The signal processing section of the sensor unit 10 performs, using correction parameters calculated in advance according to an attachment angle error of the sensor unit 10, processing for converting the acceleration data and the angular velocity data into data in an xyz coordinate system. Note that the correction parameters used by the signal processing section are determined by calibration explained below (i.e., determined on the basis of measurement data at the time when the user 2 stands still in a predetermine pose).

The signal processing section of the sensor unit 10 may perform temperature correction processing for the acceleration sensor and the angular velocity sensor. Alternatively, a function of temperature correction may be built in the acceleration sensor and the angular velocity sensor.

The acceleration sensor and the angular velocity sensor of the sensor unit 10 may output analog signals. In this case, the signal processing section of the sensor unit 10 only has to perform A/D (Analog to Digital) conversion of the output signal of the acceleration sensor and the output signal of the angular velocity sensor to generate measurement data (acceleration data and angular velocity data) and generate data for communication using the measurement data.

The communication section of the sensor unit 10 performs, for example, processing for transmitting the data received from the signal processing section of the sensor unit 10 to the communication section of the information terminal 20 and processing for receiving various control commands such as a measurement start command from the communication section of the information terminal 20 and transmitting the control commands to the signal processing section of the sensor unit 10. The signal processing section of the sensor unit 10 performs various kinds of processing corresponding to the control commands.

Note that the sensor unit 10 may have a configuration in which a part of the components is deleted or changed or other components are added as appropriate.

A function of a host apparatus (a master apparatus) is imparted to the information terminal 20 without providing a relation of a host apparatus or a subordinate apparatus in the ten sensor units 10. However, the function of the master apparatus may be imparted to any one of the ten sensor units 10.

### 1-4. Configuration of the System

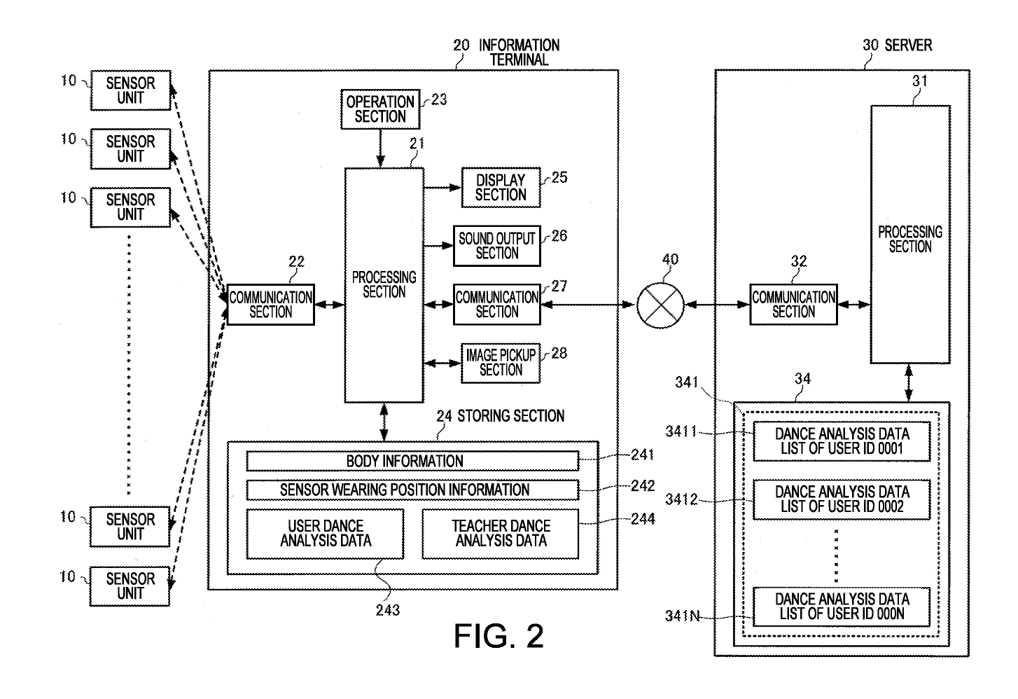

FIG. 2 is a diagram showing a configuration example of the dance analyzing system.

As shown in FIG. 2, the dance analyzing system includes, for example, the ten sensor units 10, the information terminal 20, and a server 30. The information terminal 20 and the server 30 are capable of performing information communication via a network 40 such as the Internet. In the following explanation, it is assumed that the number of the sensor units 10 worn on the body of the user 2 is ten.

First, the information terminal 20 includes a processing section 21 (which realizes functional sections: a reception processing section, a transmitting section, a presentation processing section, an evaluating section, and a notification processing section), a communication section 22, an operation section 23, a storing section 24, a display section 25, a sound output section 26, a communication section 27, and an image pickup section 28. However, the information terminal 20 may have a configuration in which a part of the components is deleted or changed or other components are added as appropriate.

The processing section 21 is configured by a CPU (Central Processing Unit), a DSP (Digital Signal Processor), an ASIC (Application Specific Integrated Circuit), and the like. The processing section 21 performs various kinds of processing according to a computer program stored in the storing section 24 and various commands input by the user via the operation section 23. The processing by the processing section 21 includes data processing for data generated by the sensor unit 10, display processing for causing the display section 25 to display an image, sound output processing for causing the sound output section 26 to output sound, and image processing for an image acquired by the image pickup section 28. Note that the processing section 21 may be configured by a single processor or may be configured by a plurality of processors.

The communication section 22 performs processing for receiving data (measurement data) transmitted from the sensor unit 10 and sending the data to the processing section 21 and processing for transmitting control commands received from the processing section 21 to the sensor unit 10.

° The operation section 23 performs processing for acquiring data corresponding to operation by the user 2 and sending the data to the processing section 21. The operation section 23 may be, for example, a touch panel display, a button, a key, or a microphone. Note that, in this embodiment, an example is explained in which the operation section 23 is the touch panel display and the user operates the operation section 23 with fingers.

The storing section 24 is configured by, for example, any one of various IC (Integrated Circuit) memories such as a ROM (Read Only Memory), a flash ROM, and a RAM (Random Access Memory) or a recording medium such as a hard disk or a memory card. The storing section 24 has stored therein computer programs for the processing section 21 to perform various kinds of calculation processing and control processing, various computer programs for realizing application functions, data, and the like.

The storing section 24 is used as a work area of the processing section 21. The storing section 24 temporarily stores the data acquired by the operation section 23, results of arithmetic operations executed by the processing section 21 according to various computer programs. Further, the storing section 24 may store data that needs to be stored for a long period among the data generated by the processing of the processing section 21. Note that details of information stored in the storing section 24 are explained below.

The display section 25 displays a processing result of the processing section 21 as characters, a graph, a table, an animation, or other images. The display section 25 may be, for example, a CRT (Cathode Ray Tube), an LCD (Liquid Crystal Display), a touch panel display, or a head mounted display (HMD). Note that one touch panel display may realize the functions of the operation section 23 and the display section 25.

The sound output section 26 outputs the processing result of the processing section 21 as sound such as voice or buzzer sound. The sound output section 26 may be, for example, a speaker or a buzzer.

The communication section 27 performs data communication with a communication section of the server 30 via the network 40. For example, after the end of dance analysis processing, the communication section 27 performs processing for receiving dance analysis data from the processing section 21 and transmitting the dance analysis data to the communication section of the server 30. For example, the communication section 27 performs processing for receiving information necessary for display of a screen from the communication section 32 of the server 30 and sending the information to the processing section 21 and processing for receiving various kinds of information from the processing section 21 and transmitting the information to the communication section of the server 30.

The image pickup section 28 is a so-called camera including a lens, a color image pickup device, and a focus adjusting mechanism. The image pickup section 28 converts, with an image pickup device, a picture of a field formed by the lens into an image. Data of the image (image data) acquired by the image pickup device is sent to the processing section 21 and stored in the storing section 24 or displayed on the display section 25. For example, image data of a plurality of frames (an example of the color moving image data) repeatedly acquired at a predetermined cycle by the image pickup device of the image pickup section 28 during a dance of the user 2 is stored in the storing section 24 as a part of the user dance analysis data 243 in a predetermined format. The image data of the plurality of frames (the example of the color moving image data) repeatedly acquired at the predetermined cycle by the image pickup device of the image pickup section 28 during the dance of the user 2 is sequentially displayed on the display section 25 as a live video.

The processing section 21 performs, according to various computer programs, processing for transmitting a control command to the sensor unit 10 via the communication section 22 and various kinds of calculation processing for data received from the sensor unit 10 via the communication section 22. The processing section 21 performs, according to various computer programs, processing for reading out the user dance analysis data 243 from the storing section 24 and transmitting the user dance analysis data 243 to the server 30 via the communication section 27. The processing section 21 performs, according to the various computer programs, for example, processing for transmitting various kinds of information to the server 30 via the communication section 27 and displaying various screens on the basis of information received from the server 30. The processing section 21 performs other various kinds of control processing.

For example, the processing section 21 executes, on the basis of at least a part of information received by the communication section 27, information received by the communication section 22, and information stored in the storing section 24, processing for causing the display section 25 to display an image (an image, a moving image, characters, signs, etc.).

For example, the processing section 21 executes, on the basis of at least a part of the information received by the communication section 27, the information received by the communication section 22, and the information stored in the storing section 24, processing for causing the sound output section 26 to output sound (sound of a musical instrument, voice, beat, metronome sound, handclapping sound, alarm sound, beep sound (buzzer sound), announce sound, etc.).

Note that a vibrating mechanism may be provided in the information terminal 20 or the sensor unit 10 to convert various kinds of information into vibration information with the vibrating mechanism and notify the user 2 of the information.

The server 30 includes a processing section 31, a communication section 32 (an example of the transmitting section), and a storing section 34. However, the server 30 may have a configuration in which a part of the components is deleted or changed or other components are added as appropriate.

The storing section 34 is configured by, for example, any one of various IC memories such as a ROM, a flash ROM, and a RAM or a recoding medium such as a hard disk or a memory card. The storing section 34 has stored therein computer programs for the processing section 31 to perform various kinds of calculation processing and control processing, various computer programs for realizing application functions, data, and the like.

The storing section 34 is used as a work area of the processing section 31. The storing section 34 temporarily stores, for example, results of arithmetic operations executed by the processing section 31 according to various computer programs. Further, the storing section 34 may store data that needs to be stored for a long time among data generated by the processing by the processing section 31. Note that details of information stored in the storing section 34 are explained below.

The communication section 32 performs data communication with the communication section 27 of the information terminal 20 via the network 40. For example, the communication section 32 performs processing for receiving dance analysis data from the communication section 27 of the information terminal 20 and sending the dance analysis data to the processing section 31. For example, the communication section 32 performs processing for transmitting information necessary for display of a screen to the communication section 27 of the information terminal 20 and processing for receiving information from the communication section 27 of the information terminal 20 and sending the information to the processing section 31.

The processing section 31 performs, according to various computer programs, processing for receiving dance analysis data from the information terminal 20 via the communication section 32 and causing the storing section 34 to store the dance analysis data (adding the dance analysis data to a dance analysis data list). The processing section 31 performs, according to the various computer programs, processing for receiving various kinds of information from the information terminal 20 via the communication section 32 and transmitting information necessary for display of various screens to the information terminal 20. The processing section 31 performs other various kinds of control processing.

### 1-5. Information Stored in the Storing Section of the Information Terminal

A not-shown dance analyzing program read out by the processing section 21 to execute dance analysis processing is stored in the storing section 24 of the information terminal 20. The dance analyzing program may be stored in a nonvolatile recording medium (a computer-readable recording medium) in advance. The processing section 21 may receive the dance analyzing program from a not-shown server or the server 30 via a network and cause the storing section 24 to store the dance analyzing program.

In the storing section 24, as shown in FIG. 2, a storage region for body information 241, a storage region for sensor wearing position information 242, a storage region for the user dance analysis data 243, and a storage region for teacher dance analysis data 244 are provided.

The body information 241 is information input to the information terminal 20 in advance by the user 2. The body information 241 includes information such as the length of the arms of the user 2, the length of the feet of the user 2, the height of the user 2, the length from the elbows to the wrists of the user 2, and the length from the knees to the ankles of the user 2. Note that input of body information by the user 2 is performed via, for example, the operation section 23.

The sensor wearing position information 242 is information registered in the information terminal 20 in advance by the user 2 for each of the sensor units. The sensor wearing position information 242 is information representing, for each of the sensor units, a correspondence relation between sensor wearing position information indicating a part on which the sensor unit 10 is worn and sensor identification information of the sensor unit 10. Note that input of sensor identification information by the user 2 is performed by, for example, short-range wireless communication (pairing) and input of sensor wearing position information by the user 2 is performed via, for example, the operation section 23.

The user dance analysis data 243 is data created in a predetermined format according to dance analysis processing (explained below) by the processing section 21. Specifically, the user dance analysis data 243 is data in which measurement data (an example of the sensing data of a motion of the user) acquired by the sensor unit 10 during a dance of the user 2 and moving image data of the user 2 acquired by the image pickup section 28 of the information terminal 20 during the dance are associated with each other in the time series order (with frames at respective times of the moving image data, measurement data acquired at the same times are associated). The moving image data is so-called moving image data with voice and includes a video track and an audio track. In the video track, moving image data of the dance by the user 2 is written. In the audio track, sound data of a musical piece used for the dance is written. Time (date and time) when the dance is performed, user identification information of the user 2, musical piece identification information of the musical piece used for the dance, and the like are added to the user dance analysis data 243.

Note that the user dance analysis data 243 is created, for example, every time dance analysis processing (explained below) is executed. The user dance analysis data 243 is uploaded from the information terminal 20 to the server 30 via the network 40.

The teacher dance analysis data 244 is dance analysis data of another user (hereinafter referred to as “teacher”; an example of the different user) who performs a dance ideal for the user 2. The teacher dance analysis data 244 is created in a format same as the format of the user dance analysis data 243. In the teacher dance analysis data 244, measurement data (an example of the sensing data of a motion of the teacher) acquired by the sensor unit 10 during a dance of the teacher and moving image data of the teacher (an example of the moving image data of the motion of the teacher) acquired by an image pickup section of an information terminal of the teacher during the dance are associated (with frames of respective times of the moving image data, measurement data acquired at the same times are associated).

Note that the teacher dance analysis data 244 can be generated using, for example, the information terminal of the user like the user dance analysis data 243. When the teacher dance analysis data 244 is generated, for example, ten sensor units 10 same as the sensor units 10 worn on the body of the user 2 are individually worn on ten parts of the body of the teacher different from one another.

In this case, the teacher dance analysis data 244 includes information concerning colors different from one another respectively corresponding to two or more sensors worn on the teacher.

Note that, in the example explained above, respective parts on which the two or more sensors are worn are determined in advance. However, when respective parts on which the two or more sensors are worn are not determined in advance, data indicating a correspondence relation between colors of the respective sensors and the parts on which the sensors are worn is added to the teacher dance analysis data 244. In that case, the teacher only has to manually input the data indicating the correspondence relation to the information terminal of the teacher.

Note that the teacher dance analysis data 244 is dance analysis data of an existing user. However, the teacher dance analysis data 244 may be dance analysis data of a virtual user generated by a computer or may be dance analysis data of a professional dancer, dance analysis data of an instructor, or the like prepared by the server 30.

Note that the teacher dance analysis data 244 is downloaded from the server 30 to the information terminal 20 via the network 40, for example, before the dance analysis processing (explained below).

In the following explanation, processing for causing the display section 25 to display a moving image (a moving image of moving image data included in the dance analysis data) stored in the storing section 24 in a predetermined format is referred to as “reproduction of the moving image”.

In the following explanation, processing for causing the sound output section 26 to output a musical piece (a musical piece based on sound data included in the dance analysis data) stored in the storing section 24 in a predetermined format is referred to as “reproduction of the musical piece”.

The “musical piece” includes not only a musical piece including a plurality of kinds of sound and but also a musical piece consisting of only handclapping and a musical piece consisting of only metronome sound. That is, the musical piece is a musical piece including sound emitted at least at a predetermined cycle. The cycle of the sound may fluctuate halfway in the musical piece or may be switched halfway in the musical piece. In the following explanation, two musical pieces having different tempos, although composed by the same composer, is treated as different musical pieces.

The number of the user dance analysis data 243 stored in the storing section 24 of the information terminal 20 is “1”. The number of the teacher dance analysis data 244 stored in the storing section 24 is “1”. It is assumed that dance analysis data necessary for the user 2 is overwritten as appropriate.

### 1-6. Information Stored in the Storing Section of the Server

In the storing section 34 of the server 30, a dance analysis data list 341 is stored for each of kinds of user identification information (for each of user IDs). That is, in the dance analysis data list 341, dance analysis data lists 3411, 3412, 3413, . . . , 341N as many as registered users are present.

The dance analysis data list 3411 includes one or a plurality of dance analysis data uploaded to the server 30 by a user allocated with a user ID “0001” and concerning the user. Note that a public flag is added to one or each of a plurality of dance analysis data. The public flag is a flag indicating whether the user permits the dance analysis data to be made public. It is assumed that setting (distinction of ON and OFF) of the public flag is performed by selection by the user when the user accesses the server 30 (when the user uploads the dance analysis data to the server 30).

The dance analysis data list 3412 includes one or a plurality of dance analysis data uploaded to the server 30 by a user allocated with a user ID “0002” and concerning the user. Note that a public flag is added to the one or each of the plurality of dance analysis data. The public flag is a flag indicating whether the user permits the dance analysis data to be made public. It is assumed that setting (ON and OFF) of the public flag is performed by selection by the user when the user accesses the server 30 (when the user uploads the dance analysis data to the server 30).

The dance analysis data list 3413 includes one or a plurality of dance analysis data uploaded to the server 30 by a user allocated with a user ID “0003” and concerning the user. Note that a public flag is added to the one or each of the plurality of dance analysis data. The public flag is a flag indicating whether the user permits the dance analysis data to be made public. It is assumed that setting (ON and OFF) of the public flag is performed by selection by the user when the user accesses the server 30 (when the user uploads the dance analysis data to the server 30).

The dance analysis data list 341N includes one or a plurality of dance analysis data uploaded to the server 30 by a user allocated with a user ID “000N” and concerning the user. Note that a public flag is added to the one or each of the plurality of dance analysis data. The public flag is a flag indicating whether the user permits the dance analysis data to be made public. It is assumed that setting (ON and OFF) of the public flag is performed by selection by the user when the user accesses the server 30 (when the user uploads the dance analysis data to the server 30).

Note that, when receiving a registration request from an information terminal of any user via the network 40 and the communication section 32, the processing section 31 of the server 30 gives a use permission of a new user ID to the user and provides, in the storing section 34, a writing region for a dance analysis data list corresponding to the user ID. Consequently, a procedure for registration in the server 30 of the user is completed.

When receiving an upload request from an information terminal of any registered user via the network 40 and the communication section 32, the processing section 31 of the server 30 permits the information terminal of the user to transmit dance analysis data. Thereafter, when receiving the dance analysis data from the information terminal of the user, the processing section 31 of the server 30 adds the received dance analysis data to a dance analysis data list corresponding to a user ID of the user.

### 1-7. Modes of the Information Terminal

Examples of modes of the information terminal 20 include a dance analysis mode (a real-time feedback mode), a data selection mode, an after-feedback mode, and an editing mode.

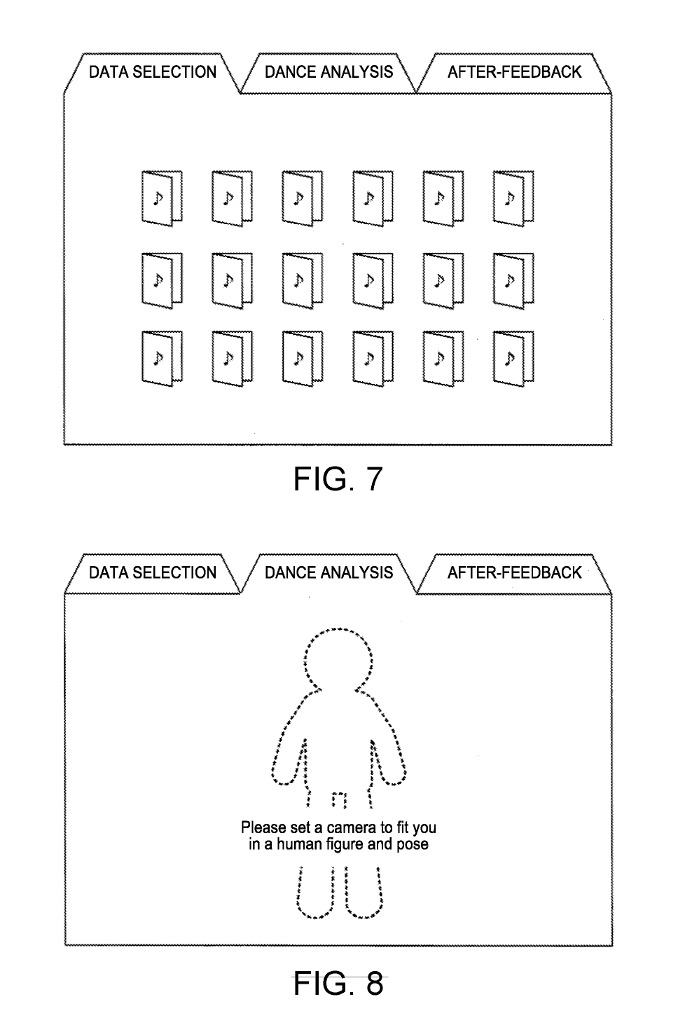

Note that, in FIG. 7, an example is shown in which a selection screen including a tab for data selection, a tab for dance analysis, and a tab for after-feedback is displayed on the display section 25. In this case, when the user 2 taps the tab for data selection with a finger, the information terminal 20 is set in the data selection mode. When the user 2 taps the tab for dance analysis with the finger, the information terminal 20 is set in the dance analysis mode. When the user 2 taps the tab for after-feedback with the finger, the information terminal 20 is set in the after-feedback mode. Note that, in FIG. 7, a tab for the editing mode is omitted. Operation of the user 2 for switching the modes of the information terminal 20 is not limited to the tap of the tabs. It is also possible to adopt a display form without the use of the tabs.

### 1-7-1. Dance Analysis Mode

The dance analysis mode is a mode in which the user 2 records dance analysis data of the user 2 in the information terminal 20 while performing dance training.

The processing section 21 of the information terminal 20 in the dance analysis mode reproduces a moving image and a musical piece included in the teacher dance analysis data 244 (an example of the presenting moving image data to the user).

During the reproduction, the processing section 21 of the information terminal 20 sequentially receives measurement data transmitted from the sensor unit 10 and drives the image pickup section 28 to acquire moving image data of the user 2.

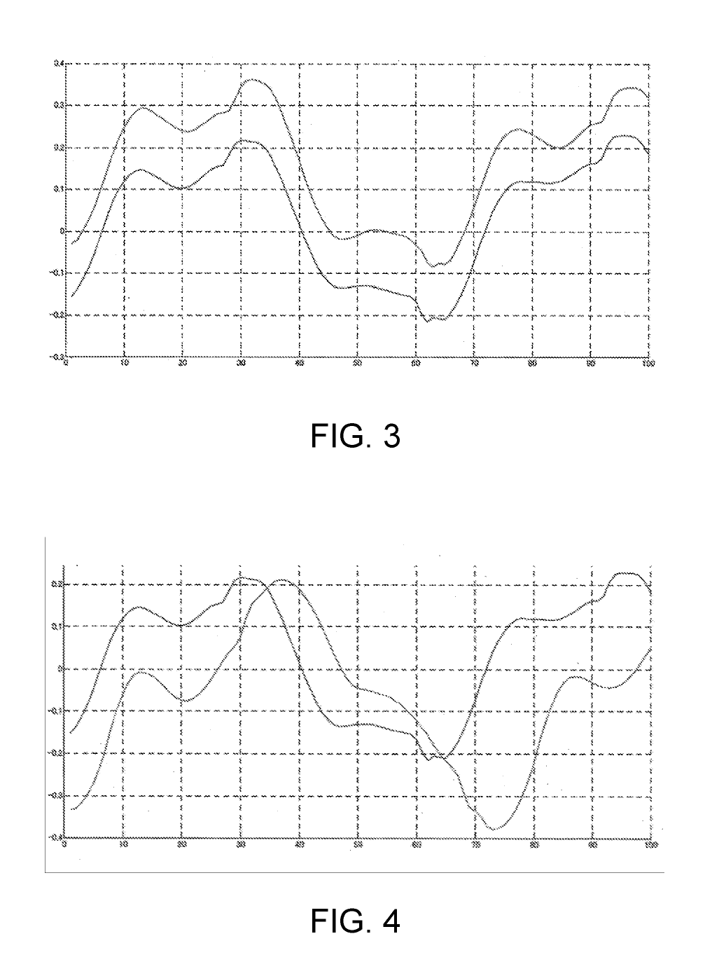

During the reproduction, the processing section 21 of the information terminal 20 calculates (an example of the evaluating) deviation between measurement data corresponding to the present reproduction part in the musical piece (deviation between the measurement data is, for example, a value on which a difference in the vertical axis direction between two waveforms shown in FIG. 3 is reflected; a method of calculating the deviation between the measurement data is explained below) among measurement data included in the teacher dance analysis data 244 and received measurement data. When the deviation exceeds a threshold, the processing section 21 notifies the user 2 (feeds back to the user 2 on a real-time basis) to that effect (an example of the result of the evaluation). An example of a form of the feedback is explained below. Note that, although the deviation between the measurement data is used for the evaluation, a correlation degree (a coincidence degree) of the measurement data may be used for the evaluation instead of the deviation between the measurement data.

During the reproduction, the processing section 21 of the information terminal 20 displays a live video (a moving image based on moving image data generated by the image pickup section 28) of the user 2 to be superimposed on or arranged side by side with a moving image of the teacher being displayed on the display section 25. Note that, in FIG. 10, an example is shown in which the live video of the user 2 is displayed to be arranged side by side with the moving image of the teacher.

When the reproduction ends, the processing section 21 of the information terminal 20 calculates a ratio of deviations in all sections of a musical piece as a synchronization ratio and displays the synchronization ratio on the display section 25 as a character image, for example, as shown in FIG. 12 (a calculating method for the synchronization ratio is explained below).

The processing section 21 of the information terminal 20 generates the user dance analysis data 243 on the basis of the measurement data transmitted from the sensor unit 10 during the reproduction and the moving image data generated by the image pickup section 28 during the reproduction and stores the user dance analysis data 243 in the storing section 24 in a predetermined format. Note that sound data of the musical piece incorporated in the user dance analysis data 243 is the same as sound data of the musical piece included in the teacher dance analysis data 244.

In this way, the processing section 21 of the information terminal 20 in the dance analysis mode notifies the user 2 of the measurement data of the user and the measurement data of the teacher in an appropriate form and at appropriate timing to facilitate motion learning by the user 2 alone.

Note that the processing section 21 in the dance analysis mode may be able to repeatedly reproduce a portion designated by the user 2 (a portion that the user 2 desires to practice or check).

As a method of the repeated reproduction, for example, at least one of (1) and (2) described below can be adopted.

(1) The processing section 21 repeatedly reproduces at least one of a moving image of the teacher and a moving image of the user 2 (e.g., repeatedly reproduces both of the moving image of the teacher and the moving image of the user 2).

(2) The processing section 21 repeatedly reproduces a portion desired by the user 2 in at least one of the moving image of the teacher and the moving image of the user 2.

As a method of selecting a repeated portion, for example, at least one of (a) and (b) described below can be adopted.

(a) The processing section 21 causes the user 2 to designate a desired part.

(b) The processing section 21 presents a portion where deviation exceeds the threshold in the musical piece (the moving image) to the user 2. When the user 2 selects the part, the processing section 21 repeatedly reproduces the part.

Note that a flow of the operation of the information terminal 20 in the dance analysis mode is explained below.

### 1-7-2. Data Selection Mode

The data selection mode is a mode for the user 2 to select one of dance analysis data stored in the server 30 and downloading the selected dance analysis data to the information terminal 20.

An example is explained in which, prior to the dance analysis mode, the user 2 selects one of dance analysis data of users other than the user 2 as teacher dance analysis data.

The processing section 21 of the information terminal 20 in the data selection mode accesses the server 30 via the network 40 and receives, from the server 30, list information of dance analysis data, public flags of which are on, among the dance analysis data of the users other than the user 2.

Subsequently, the processing section 21 of the information terminal 20 displays, on the display section 25, one or a plurality of musical piece names (see FIG. 7) included in the received list information and causes the user 2 to select a desired musical piece name. Subsequently, the processing section 21 of the information terminal 20 displays a list of dance analysis data corresponding to the musical piece name selected by the user 2 and causes the user 2 to select desired dance analysis data. Note that, in FIG. 7, a state in which a list of dance analysis data selectable by the user 2 is displayed on the display section 25 is shown. The user 2 selects desired one dance analysis data out of the list. The selection by the user 2 is performed via the operation section 23.

The processing section 21 of the information terminal 20 accesses the server 30 via the network 40 and downloads the dance analysis data selected by the user 2 from the server 30. That is, the processing section 21 receives the data analysis data selected by the user 2 from the server 30 and writes the data analysis data in the storing section 24 as the teacher dance analysis data 244.

However, when the teacher dance analysis data 244 including content same as content of teacher dance analysis data that should be written is already stored in the storing section 24, the processing section 21 of the information terminal 20 omits the download.

The server 30 may add data (a thumbnail) for viewing to the list information to enable the user 2 to check content of dance analysis data before downloading the dance analysis data.

Note that, in the above explanation, prior to the dance analysis mode, the information terminal 20 causes the user 2 to select one of the dance analysis data of the other users as the teacher dance analysis data. However, similarly, it is also possible that, prior to the after-feedback mode, the information terminal 20 causes the user 2 select one of dance analysis data of the users as a target of after-feedback.

Flows of the operations of the information terminal 20 and the server 30 in the dance analysis mode are explained below.

### 1-7-3. After-Feedback Mode

The after-feedback mode is a mode in which the user 2 reviews a dance of the user 2 after dance training.

The processing section 21 of the information terminal 20 in the after-feedback mode reproduces a moving image included in the user dance analysis data 243 while reproducing a moving image and a musical piece included in the teacher dance analysis data 244.

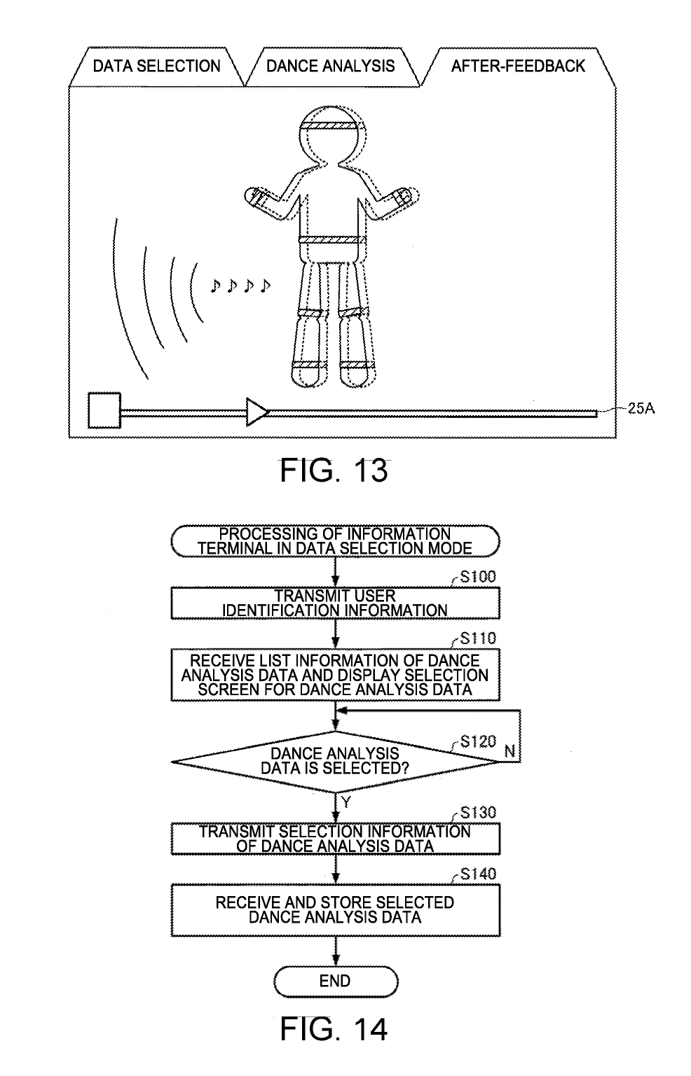

During the reproduction, the processing section 21 of the information terminal 20 displays a moving image of the user 2 to be superimposed on or arranged side by side with a moving image of the teacher being displayed on the display section 25. Note that, in FIG. 13, an example is shown in which the moving image of the user 2 is displayed to be superimposed on the moving image of the teacher.

Note that at least one of moving image data of the teacher and moving image data of the user 2 may be actually-photographed image data obtained by photographing an existing user but may be CG (Computer Graphics) animation data including a human figure model.

When the reproduction ends, the processing section 21 of the information terminal 20 calculates a ratio of deviations in all sections of the musical piece as a synchronization ratio and displays the synchronization ratio on the display section 25 as a character image, for example, as shown in FIG. 12. Note that a calculating method for the synchronization ratio is explained below.

During the reproduction, the processing section 21 of the information terminal 20 calculates deviation between measurement data corresponding to the present reproduction part in the musical piece among measurement data included in the teacher dance analysis data 244 and measurement data included in the user dance analysis data 243. When the deviation is larger than the threshold, the processing section 21 notifies the user 2 (feeds back to the user 2 on a real-time basis) to that effect. An example of a form of the feedback is explained below.

As shown in FIG. 13, a control button 25A including a play button and a pause button is disposed in the display section 25 in the after-feedback mode. The user 2 can change the present reproduction part in the musical piece, adjust reproduction speed, and stop the reproduction by operating the control button 25A with a finger. Note that the control button 25A is a part of the operation section 23.

Note that a flow of the operation of the information terminal 20 in the after-feedback mode is explained below.

### 1-7-4. Editing Mode

The editing mode is a mode in which the user 2 performs editing of the user dance analysis data 243 or the teacher dance analysis data 244.

The processing section 21 of the information terminal 20 in the editing mode causes the user 2 to edit sound data of a musical piece included in the user dance analysis data 243 or the teacher dance analysis data 244.

The editing includes, for example, extracting a section of a portion of a musical piece and changing a part of a portion included in the musical piece. For example, the change of the part means changing the rhythm of handclapping included in the musical piece to another rhythm and changing a tone of a base part included in the musical piece to another tone.

When a section (the section means a section in a time direction) of a portion of sound data included in the user dance analysis data 243 is extracted, the processing section 21 of the information terminal 20 extracts the same section of measurement data and moving image data included in the user dance analysis data 243, creates new dance analysis data according to the extracted sound data, measurement data, and moving image data, and stores the dance analysis data in the storing section 24.

### 1-8. Form of Feedback

Several examples of a form of feedback are explained.

As feedback to the user 2 by the processing section 21 of the information terminal 20, there are, for example, (1) feedback by sound, (2) feedback by a moving image, (3) feedback by vibration, and (4) feedback by a tactile sense. For example, the user 2 can select one or more of (1) to (4) as a form of the feedback in advance and designate the feedback in the information terminal 20. The designation by the user 2 is performed via the operation section 23 of the information terminal 20.

The feedback (1) to the feedback (4) are explained in order below.

### (1) Feedback by Sound

When the sensor unit 10, the deviation of which exceeds the threshold, is present among the ten sensor units 10, the processing section 21 of the information terminal 20 causes the sound output section 26 to output beep sound (buzzer sound). When the sensor unit 10 is absent, the processing section 21 of the information terminal 20 does not cause the sound output section 26 to output the beep sound (the buzzer sound). As the absolute value of the deviation is larger, the processing section 21 of the information terminal 20 causes the sound output section 26 to output larger beep sound (buzzer sound).

Note that the beep sound (the buzzer sound) is set to characteristic sound (sound with an unstable pitch, a discord, etc.) to be able to be distinguished from sound included in a musical piece being reproduced.

Note that alarm sound or announce voice may be used instead of the beep sound (the buzzer sound). Handclapping having a rhythm pattern different from a rhythm pattern of handclapping included in the musical piece may be used. As the announce voice, voice indicating a part on which the sensor unit 10, deviation of which exceeds the threshold, is worn such as “the position of the right wrist deviates from an ideal position” may be used. As the announce voice, voice indicating a degree of deviation such as “deviation is large” may be used.

### (2) Feedback by a Moving Image

When the sensor unit 10, the deviation of which exceeds the threshold, is present among the ten sensor units 10, the processing section 21 of the information terminal 20 highlights a part on which the sensor unit 10 is worn in a live video (see FIGS. 10 and 11). When the sensor unit 10 is absent, the processing section 21 of the information terminal 20 does not perform the highlighting. As the absolute value of the deviation is larger, the processing section 21 of the information terminal 20 increases a highlighting degree.

The highlighting of the part in the live video is performed as explained below. That is, the processing section 21 of the information terminal 20 detects a region having a color same as a color of a wearing fixture of the sensor unit 10 from frames of the live video and improves the luminance of the detected region in the frames. It is assumed that time required for processing for the detection from the frames and processing for the luminance improvement is shorter than a frame cycle of the live video. In this case, the highlighting of the part in the live video is performed sequentially (on a real-time basis).

Note that the luminance of the region is set to a sufficiently high value such that the region can be distinguished from the other portions of the live video. Instead of improving the luminance of the region, the chroma of the region may be improved or a peripheral region of the region may be highlighted together with the region. The region may be flashed to be able to be distinguished from the other portions of the live video.

FIG. 10 shows a state in which the positions of the right wrist and the right elbow of the user 2 deviate from ideal positions and the vicinity of the right wrist and the vicinity of the right elbow are highlighted on a screen of the display section 25.

FIG. 11 shows a state in which the positions of the left wrist and the left elbow deviate from ideal positions and the vicinity of the left wrist and the vicinity of the left elbow are highlighted on the screen of the display section 25.

Note that, in FIGS. 10 and 11, an example is shown in which a live video of the user 2 viewed from the back side (a live video obtained by horizontally reversing the live video acquired by the image pickup section 28) is displayed on the display section 25. A live video of the user 2 viewed from the front side (a live video obtained by not horizontally reversing the live video acquired by the image pickup section 28) may be displayed on the display section 25.

In FIGS. 10 and 11, an example is shown in which the moving image of the teacher and the live video of the user 2 are displayed to be arranged side by side with each other. However, the moving image of the teacher and the live video of the user 2 may be displayed one on top of the other.

### (3) Feedback by Vibration

In order to perform the feedback by vibration, vibrating mechanisms are respectively provided in the ten sensor units 10. The processing section 21 of the information terminal 20 gives a driving signal for the vibrating mechanisms to the sensor units 10 via short-range wireless communication or the like to thereby vibrate the vibrating mechanisms of the sensor units 10.

When the sensor unit 10, the deviation of which exceeds the threshold, is present among the ten sensor units 10, the processing section 21 of the information terminal 20 gives the driving signal to the sensor unit 10. When the sensor unit 10 is absent, the processing section 21 of the information terminal 20 does not give the driving signal. As the absolute value of the deviation is larger, the processing section 21 of the information terminal 20 gives a stronger driving signal (a driving signal for more strongly vibrate the vibrating mechanism).

Note that a vibration pattern may be changed according to the absolute value of the deviation instead of changing the strength of the vibration according to the absolute value of the deviation. A combination of the strength of the vibration and the pattern of the vibration may be changed according to the absolute value of the deviation.

### (4) Feedback by a Tactile Sense

In order to perform the feedback by a tactile sense, a tactile feedback function by a haptic technology may be mounted on each of the ten sensor units 10.

The haptic technology is a publicly-known technology for generating a stimulus such as a stimulus by a movement (vibration) or an electric stimulus to give cutaneous sensation feedback to the user 2. The processing section 21 of the information terminal 20 gives a driving signal to the sensor units 10 via short-range wireless communication to thereby turn on the tactile feedback function of the sensor units 10.

When the sensor unit 10, the deviation of which exceeds the threshold, is present among the ten sensor units 10, the processing section 21 of the information terminal 20 gives the driving signal to the sensor unit 10. When the sensor unit 10 is absent, the processing section 21 of the information terminal 20 does not give the driving signal. The processing section 21 of the information terminal 20 gives a driving signal corresponding to the magnitude of the deviation to thereby generate tactile feedback in a direction in which the deviation is compressed. Consequently, it is possible to guide the user 2 such that the position of a part on which the sensor unit 10 is worn moves to an ideal position.

### 1-9. Calibration

In the beginning of the dance analyzing mode (before reproduction of a musical piece), the processing section 21 of the information terminal 20 performs calibration on the respective sensor units 10 worn on the user 2.

The calibration of the sensor units 10 is processing for setting correction parameters of signal processing implemented in the sensor units 10. When the correction parameters are correctly set, it is possible to correctly compare measurement data of the user 2 and measurement data of the teacher (i.e., correctly evaluate a dance of the user 2) irrespective of an attachment error of the sensor units 10 to the user 2 and a difference in physique.

The calibration of the sensor unit 10 is performed, for example, in a procedure explained below.

First, the processing section 21 of the information terminal 20 starts display of a live video on the display section 25 and transmits a measurement start command to the sensor unit 10 to start acquisition of measurement data. Then, the processing section 21 of the information terminal 20 instructs the user 2 to take a predetermined pose. For example, the processing section 21 displays, on the display section 25, a human figure contour line (see a dotted line frame in FIG. 8; hereinafter referred to as “guide frame”) that takes the predetermined pose as shown in FIG. 8. In FIG. 8, an example is shown in which a character image “please set a camera to be fit in a human figure and pose” is displayed on the display section 25.

The user 2 can easily and surely take the predetermined pose by adjusting the position and the posture of the information terminal 20 and the posture of the user 2 such that the body of the user 2 is fit in the guide frame (the dotted line frame in FIG. 8) while checking the screen of the display section 25.

When the user 2 takes the predetermined pose and stands still, a value of measurement data transmitted from the sensor unit 10 to the information terminal 20 is stabilized. The wearing fixtures (colored in different colors for each of the parts) photographed in the live video should be fit within the human figure guide frame.

Therefore, the processing section 21 of the information terminal 20 monitors the value of the measurement data received from the sensor unit 10 and detects, through image processing, the wearing fixtures (colors in different colors for each of the parts) photographed in the live video (the image processing is processing called pattern recognition or the like).

When the value of the measurement data is stabilized and the wearing fixtures are fit within the human figure guide frame, the processing section 21 of the information terminal 20 determines that the user 2 stands still in the predetermined pose. The processing section 21 of the information terminal 20 determines correction parameters for the sensor unit 10 using the value of the measurement data received from the sensor unit 10 in a period in which the user 2 stands still in the predetermined pose and body information of the user 2 and transmits the correction parameters to the sensor unit 10 via short-range wireless communication or the like.

The sensor unit 10 receives the correction parameters and sets the correction parameters in the signal processing section of the sensor unit 10. Consequently, the calibration of the sensor unit 10 is completed.

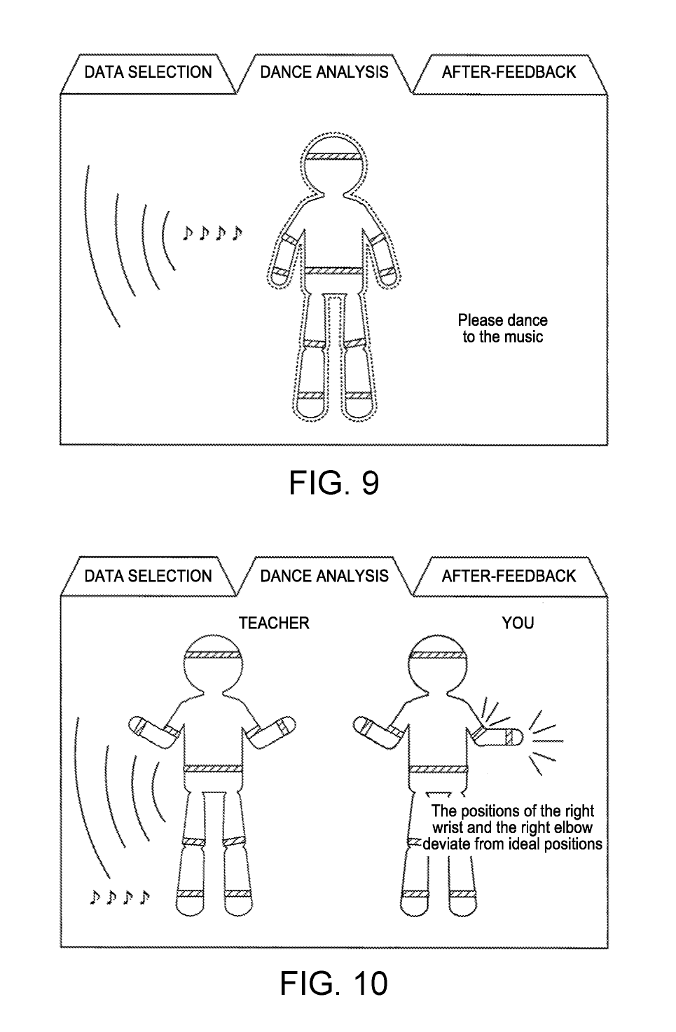

When the calibration for all the sensor units 10 worn on the body of the user 2 is completed, the processing section 21 of the information terminal 20 starts reproduction of a musical piece and a moving image included in the teacher dance analysis data 244 and notifies the user 2 of permission of a dance start. In FIG. 9, a state is shown in which the permission of the dance start is notified to the user 2 by displaying a character image “please dance to a musical piece” on the display section 25. Note that the notification may be performed by another form.

### 1-10. Calculation of Deviation

A method of calculating deviation between the measurement data included in the teacher dance analysis data 244 and measurement data transmitted from the sensor unit 10 or the measurement data included in the user dance analysis data 243 (an example of the evaluation of a motion of the user) is explained below.

The measurement data included in the teacher dance analysis data 244 is referred to as “measurement data of the teacher”. Measurement data for one musical piece transmitted from the sensor unit 10 or the measurement data included in the user dance analysis data 243 is referred to as “measurement data of the user”. It is assumed that deviation is calculated for each of sections of a musical piece (e.g., for each ½ beat, every 1/60 second, or every one bar).

First, measurement data of certain one teacher includes measurement data concerning parts of maximum ten types. The respective measurement data of the parts of the ten types include measurement data of six types, i.e., three-axis acceleration data and three-axis angular velocity data. Therefore, the measurement data of the teacher includes measurement data of sixty types in different parts or having different measurement amounts.

Similarly, measurement data of certain one user includes measurement data concerning parts of maximum ten types. The respective measurement data of the parts of the ten types include measurement data of six types, i.e., three-axis acceleration data and three-axis angular velocity data. Therefore, the measurement data of the user includes measurement data of sixty types in different parts or having different measurement amounts.

The processing section 21 of the information terminal 20 calculates, for each of the parts and for each of the measurement amounts, a difference between measurement data of the teacher and measurement data of the user associated with the same timing of a musical piece. The processing section 21 of the information terminal 20 calculates, as deviation of the timing, a sum of the magnitudes of differences calculated for each of the parts and for each of the measurement amounts concerning the timing.

FIG. 3 is a graph for comparing posture data (a time integral value of angular velocity data; the same applies below) of the waist of the teacher and posture data of the waist of the user concerning the same section of the same musical piece. The horizontal axis of FIG. 3 is a time axis and the vertical axis is an axis of the posture data. One of two curves shown in FIG. 3 is the posture data of the teacher and the other is the posture data of the user.

FIG. 4 is a graph for comparing posture data of the waist of the teacher and posture data of the waist of the user concerning the same section of the same musical piece. The horizontal axis of FIG. 4 is a time axis and the vertical axis is an axis of the posture data. One of two curves shown in FIG. 4 indicates the posture data of the teacher and the other indicates the posture data of the user.

In an example shown in FIG. 3, there is slight deviation in the vertical axis direction between the measurement data of the teacher and the measurement data of the user. However, there is almost no deviation in the horizontal axis direction.

On the other hand, in an example shown in FIG. 4, there is large deviation in the horizontal axis direction between the measurement data of the teacher and the measurement data of the user.

Therefore, in the example shown in FIG. 3, deviation of timings in the section should be recorded small compared with the deviation in the example shown in FIG. 4. In the example shown in FIG. 4, deviation of timings in the section should be recorded large compared with the deviation in the example shown in FIG. 3.

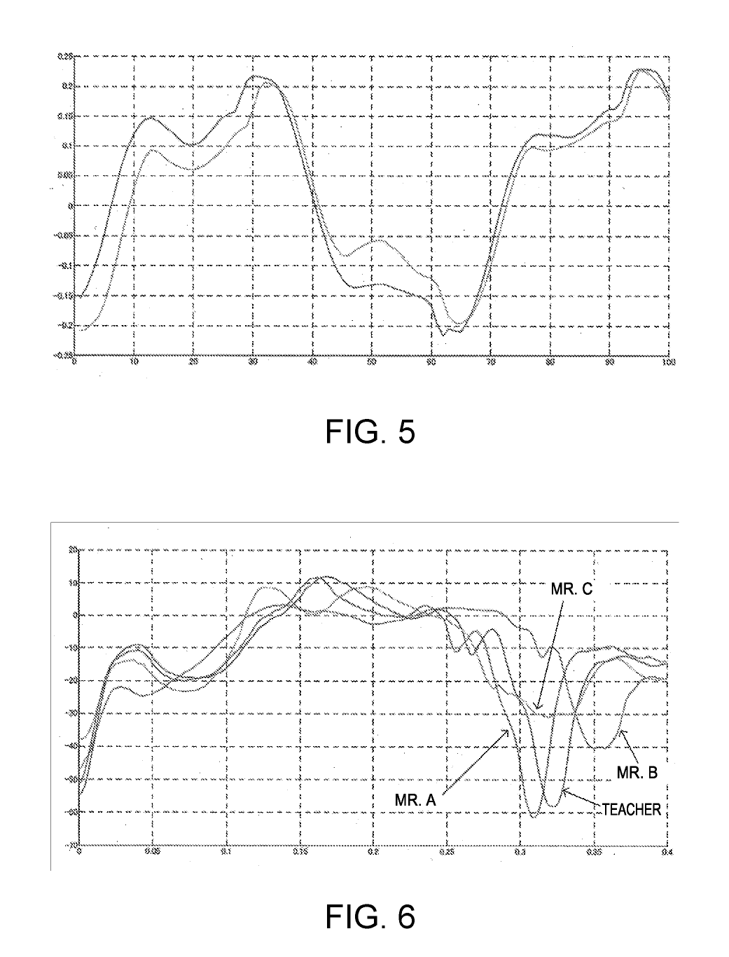

FIG. 5 is a graph for comparing posture data of the waist of the teacher and posture data of the waist of the user concerning another same section of the same musical piece. The horizontal axis of FIG. 5 is a time axis and the horizontal axis of FIG. 5 is an axis of the posture data. One of two curves shown in FIG. 5 indicates the posture data of the teacher and the other indicates the posture data of the user.

In an example shown in FIG. 5, there is almost no deviation in the vertical axis direction and the horizontal axis direction between the measurement data of the teacher and the measurement data of the user.

Therefore, in the example shown in FIG. 5, deviation of timings in the section should be recorded small compared with the deviation in the example shown in FIG. 3 or FIG. 4.

FIG. 6 is a graph for comparing acceleration data of the waist of the teacher and acceleration data of the waists of three users concerning another same section of the same musical piece. The horizontal axis of FIG. 6 is a time axis and the vertical axis is an axis of the acceleration data. One (“teacher”) of four curves shown in FIG. 6 indicates the acceleration data of the teacher and the other three (“Mr. A”, “Mr. B”, and “Mr. C”) indicate the acceleration data of three users A, B, and C.

In an example shown in FIG. 6, the acceleration data of the users A, B, and C deviate from the acceleration data of the teacher. However, an irregular pattern of the curve of the acceleration data of the user A is similar to an irregular pattern of the acceleration data of the teacher. Therefore, the deviation concerning the user A should be recorded smaller than the deviations concerning the other users B and C.

### 1-11. Calculation of a Synchronization Ratio

A synchronization ratio can be calculated according to a procedure explained below.

First, during the reproduction of the musical piece, the processing section 21 of the information terminal 20 accumulates the absolute value of deviation of measurement data calculated concerning sections every time the information terminal 20 calculates the deviation.

The processing section 21 repeats the accumulation of the absolute value until the reproduction of the musical piece is completed and calculates a cumulative value at a point in time of the completion as a sum of absolute values concerning the entire musical piece.

Subsequently, the processing section 21 calculates a synchronization ratio by dividing the sum by a predetermined ideal value.

The predetermined ideal value is a value close to zero. However, the predetermined ideal value is desirably set to a larger value as the number of the sensor units 10 worn on the user 2 is larger or the number of sections of a musical piece used for a dance is larger.

Therefore, in reproducing the musical piece, the processing section 21 of the information terminal 20 applies the number of the sensor units 10 and the number of sections of the musical piece to a predetermined function to calculate the ideal value. The predetermined function is prepared in advance by a manufacturer or the like of the dance analyzing system and stored in the storing section 24.

### 1-12. A Flow of the Information Terminal and a Flow of the Server in the Data Selection Mode

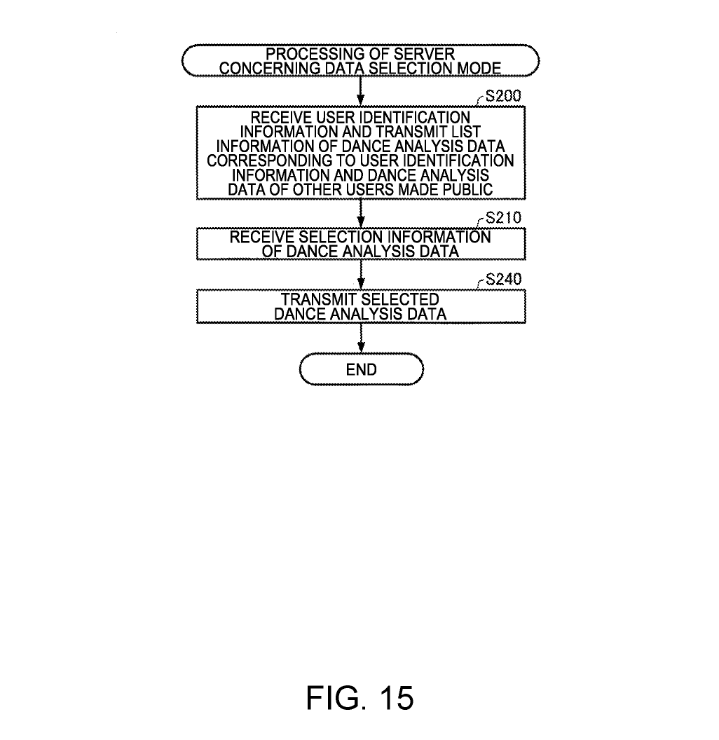

FIG. 14 is a flowchart of the information terminal in the data selection mode. FIG. 15 is a flowchart of the server that performs communication with the information terminal that is in the data selection mode.

The processing section 21 of the information terminal 20 executes a computer program stored in the storing section 24 to thereby execute processing according to a procedure of the flowchart of FIG. 14. The processing section 31 of the server 30 executes a computer program stored in the storing section 34 to thereby execute processing according to a procedure of the flowchart of FIG. 15. The flowcharts of FIGS. 14 and 15 are explained below.

First, the processing section 21 of the information terminal 20 transmits user identification information (a user ID) allocated to the user 2 to the server 30 (S100 in FIG. 14).

Subsequently, the processing section 31 of the server 30 receives the user identification information and transmits list information of dance analysis data corresponding to the user identification information (list information of dance analysis data of the user 2) and list information of dance analysis data, public flags of which are on, among dance analysis data of the users other than the user 2 (list information of dance analysis data of the other users) (S200 in FIG. 15).

Subsequently, the processing section 21 of the information terminal 20 receives the list information of the dance analysis data of the user 2 and the list information of the dance analysis data of the other users and causes the display section 25 to display at least one of a list of the dance analysis data of the user 2 and a list of the dance analysis data of the other users (S110 in FIG. 14).

Note that, before displaying the list of the dance analysis data, the processing section 21 may display one or a plurality of musical piece names included in the list information on the display section 25 and cause the user 2 to select a desired musical piece name to exclude dance analysis data corresponding to the musical piece names not selected by the user 2 from the list of the dance analysis data that the processing section 21 causes the display section 25 to display. Consequently, it is possible to reduce an information amount of a list that should be displayed.

The processing section 21 of the information terminal 20 stays on standby until dance analysis data is selected (N in S120 in FIG. 14). When the dance analysis data is selected (Y in S120 in FIG. 14), the processing section 21 of the information terminal 20 transmits selection information (a selection result by the user 2) of the dance analysis data to the server 30 (S130 in FIG. 14).

Subsequently, the processing section 31 of the server 30 receives the selection information of the dance analysis data from the information terminal 20 (S210 in FIG. 15).

Subsequently, the processing section 31 of the server 30 transmits the dance analysis data selected by the user 2 and indicated by the selection information to the information terminal 20 (S240 in FIG. 15) and ends the processing.

Subsequently, when receiving the dance analysis data from the server 30, the processing section 21 of the information terminal 20 stores the dance analysis data in the storing section 24 (S140 in FIG. 14) and ends the processing.

Note that, in the flowchart of FIG. 14, the order of the steps may be changed as appropriate in a changeable range, a part of the steps may be deleted or changed, or other steps may be added. Similarly, in the flowchart of FIG. 15, the order of the steps may be changed as appropriate in a changeable range, a part of the steps may be deleted or changed, or other steps may be added.

### 1-13. A Flow of the Information Terminal in the Dance Analysis Mode

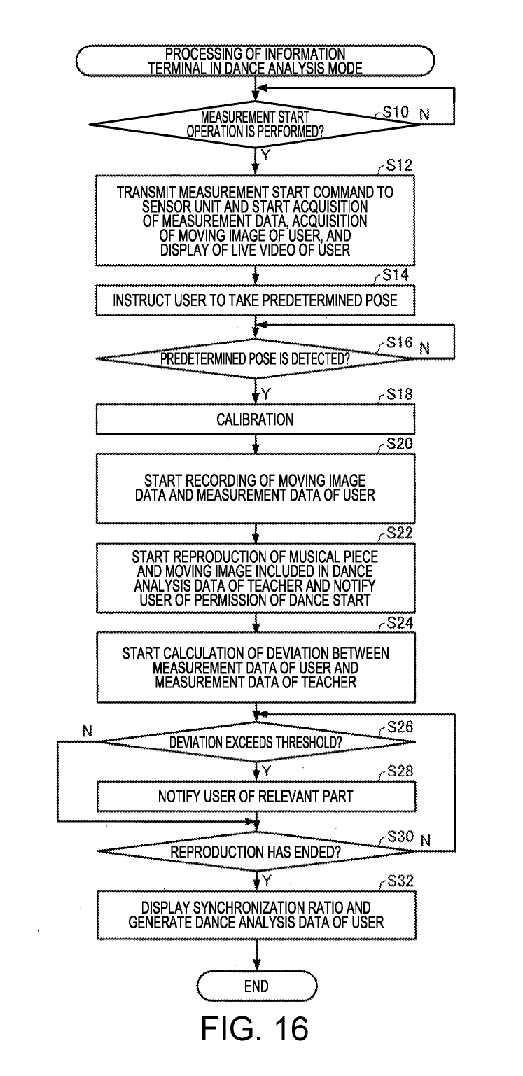

FIG. 16 is a flowchart showing an example of a procedure of processing (dance analysis processing) of the processing section 21 in the dance analysis mode. The processing section 21 executes a computer program stored in the storing section 24 to thereby execute the processing according to the procedure of the flowchart of FIG. 16. The flowchart of FIG. 16 is explained below.

First, the processing section 21 stays on standby until measurement start operation is performed by the user 2 (N in S10). When the measurement start operation is performed (Y in S10), the processing section 21 transmits a measurement start command to all the sensor units 10 worn on the body of the user 2 and starts reception of measurement data from the sensor units 10, acquisition of moving image data of the user 2, and display of a live video of the user 2 (S12).

Subsequently, the processing section 21 instructs the user 2 to take a predetermined pose (S14). The user 2 takes the predetermined pose according to the instruction and stands still.

Subsequently, the processing section 21 determines on the basis of the measurement data and the live video acquired from the sensor units 10 whether the user 2 stands still in the predetermined pose for a predetermined period (S16). When determining that the user 2 stands sill (Y in S16), the processing section 21 performs calibration of the sensor units 10 (S18). Otherwise (N in S16), the processing section 21 stays on standby.

Subsequently, the processing section 21 starts accumulation (i.e., recording) of moving image data generated by the image pickup section 28 in the storing section 24 and starts accumulation (i.e., recording) of measurement data received from the sensor units 10 in the storing section 24 (S20).

Subsequently, the processing section 21 starts reproduction of a musical piece and a moving image included in the teacher dance analysis data 244 and notifies the user 2 of permission of a dance start (S22).

Note that, in step S22, the processing section 21 displays a moving image of the teacher on the display section 25 to be arranged side by side with or superimposed on the live video of the user 2 (in FIG. 10, an example is shown in which the moving image of the teacher and the live video of the user 2 are displayed to be arranged side by side with each other). When confirming the start of the reproduction of the musical piece or the notification of the permission, the user 2 starts a dance motion.

Note that the user 2 can recognize according to the start of the reproduction of the musical piece that the dance start is permitted. Therefore, in step S22, the processing section 21 may omit the notification of the permission to the user 2.

Subsequently, the processing section 21 starts calculation of deviations between the measurement data respectively received from all the sensor units 10 worn on the body of the user 2 and the measurement data included in the teacher dance analysis data 244 (S24).

Subsequently, the processing section 21 determines whether the sensor unit 10, the deviation of which exceeds the threshold, is present (an example of the evaluation of a motion of the user) (S26). When determining that the sensor unit 10 is present (Y in S26), the processing section 21 notifies the user 2 to that effect (S28). Otherwise (S26), the processing section 21 does not perform the notification. That is, the processing section 21 performs real-time feedback.

Subsequently, the processing section 21 determines whether the reproduction of the musical piece (and the reproduction of the moving image) has ended. When determining that the reproduction has ended (Y in S30), the processing section 21 shifts to generation processing for dance analysis data (S32). Otherwise (N in S30), the processing section 21 returns to the determination processing for the deviation (S26).

In the generation processing for dance analysis data (S32), the processing section 21 calculates a synchronization ratio and displays the synchronization ratio on the display section 25. The processing section 21 generates the user dance analysis data 243 in a predetermined format on the basis of the moving image data and the measurement data accumulated in the storing section 24 and sound data of the musical piece included in the teacher dance analysis data 244 and stores the user dance analysis data 243 in the storing section 24. Then, the processing section 21 ends the flow.

Note that, in step S32, the processing section 21 may automatically upload the generated user dance analysis data 243 to the server 30.

In the flowchart of FIG. 16, the order of the steps may be changed as appropriate in a changeable range, a part of the steps may be deleted or changed, or other steps may be added.

1-14. A Flow of the Information Terminal in the after-Feedback Mode

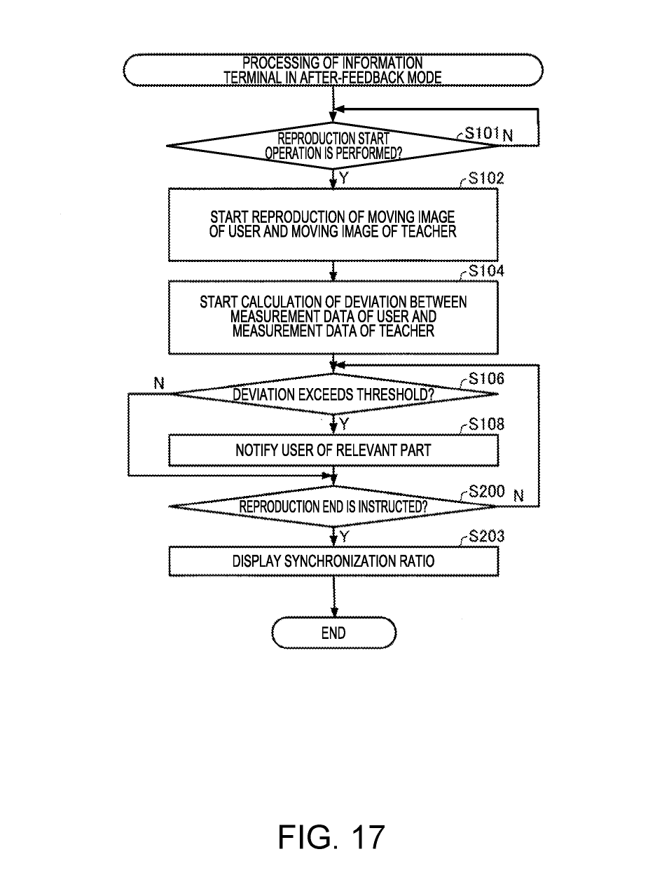

FIG. 17 is a flowchart of the information terminal in the after-feedback mode. The processing section 21 executes a computer program stored in the storing section 24 to thereby execute processing according to, for example, a procedure of the flowchart of FIG. 17. The flowchart of FIG. 17 is explained below.

First, the processing section 21 stays on standby until reproduction start operation is performed by the user 2 (N in S101). When the reproduction start operation is performed (Y in S101), the processing section 21 starts reproduction of a moving image included in the user dance analysis data 243, reproduction of a moving image included in the teacher dance analysis data 244, and reproduction of a musical piece included in the teacher dance analysis data 244 (S102).

Note that, in step S102, the processing section 21 may reproduce a musical piece included in the user dance analysis data 243 instead of reproducing the musical piece included in the teacher dance analysis data 244.

Subsequently, the processing section 21 starts calculation of deviation between measurement data included in the user dance analysis data 243 and measurement data included in the teacher dance analysis data 244 (S104).

Subsequently, the processing section 21 determines whether the sensor unit 10, deviation of which exceeds the threshold, is present (S106). When determining that the processing section 21 is present (Y in S106), the processing section 21 notifies the user 2 to that effect (S108). That is, the processing section 21 performs after-feedback.

Subsequently, the processing section 21 determines whether reproduction end operation by the user 2 is performed (S200). When determining that the reproduction end operation is performed (Y in S200), the processing section 21 calculates a synchronization ratio and displays the synchronization ratio on the display section 25 (S203) and ends the flow. Otherwise (N in S200), the processing section 21 returns to the determination processing for the deviation (S106).

Note that, in step S203, the processing section 21 may calculate and display a synchronization ratio of all sections of the musical piece when the reproduction ends in the end of the musical piece and may calculate and display, when the reproduction ends halfway in the musical piece, a synchronization ratio of sections from the beginning of the musical piece to a part where the reproduction ends.

In the flowchart of FIG. 17, the order of the steps may be changed as appropriate in a changeable range, a part of the steps may be deleted or changed, or other steps may be added.

In the flowchart of FIG. 17, steps concerning a pause of the reproduction, resumption of the reproduction, adjustment of reproduction speed, and the like are omitted.

### 1-15. Action and Effect of the Embodiment

As explained above, the information terminal 20 in this embodiment includes the reception processing section that receives, via the network 40, measurement data of the teacher and moving image data of the teacher associated with the measurement data of the teacher from the server 30, the presentation processing section that presents the moving image data of the teacher to the user 2, the evaluating section that performs, during the presentation of the moving image data, evaluation of a motion of the user 2 using the measurement data of the user 2 and the measurement data of the teacher, and the notification processing section that notifies the user 2 of a result of the evaluation during the presentation of the moving image data.

Specifically, during the reproduction of the moving image data of the teacher, the evaluating section determines whether deviation between the measurement data of the user 2 and the measurement data of the teacher exceeds the threshold. During the reproduction of the moving image data of the teacher, the notification processing section sequentially notifies the user 2 of a result of the determination (feeds back the result of the determination to the user 2 on a real-time basis). Therefore, the information terminal 20 in this embodiment can present a motion of the teacher to the user 2 to urge the user 2 to perform a motion same as the motion of the teacher and, at timing when deviation between the motion of the teacher and the motion of the user 2 exceeds the threshold, can notify the user 2 to that effect (feeds back to the user to that effect on a real-time basis).

Therefore, the user 2 can imitate the motion of the teacher while visually checking the motion. When the motion of the user deviates from the motion of the teacher by a fixed amount or more during the imitating motion, at timing when the motion deviates, the user 2 can recognize the fact that the motion deviates. Therefore, the user 2 can easily grasp during practice (instantaneously and accurately grasp) which portion of the motion of the user 2 should be improved to bring the motion of the user 2 close to the motion of the teacher. Therefore, the information terminal 20 is effective for personal practice for the user 2 to learn the motion same as the motion of the teacher.

The information terminal 20 in this embodiment uses the two or more sensor units 10 worn on the parts of the body of the teacher different from one another. Therefore, the information terminal 20 can reflect, on the measurement data of the teacher, movements of the joints of the teacher, movements of a positional relation of the hands and the feet of the teacher, and movements of a positional relation of both the hands of the teacher, and the like.

The information terminal 20 in this embodiment uses the two or more sensor units 10 worn on the parts of the body of the user 2 different from one another. Therefore, the information terminal 20 can reflect, on the measurement data of the user 2, movements of the joints of the user 2, movements of a positional relation of the hands and the feet of the user 2, movements of a positional relation of both the hands of the user 2, and the like.

In the dance analyzing system in this embodiment, the parts on which the sensor units 10 are worn in the body of the user 2 and the parts on which the sensor units 10 are worn in the body of the teacher coincide with each other (i.e., the parts of the body on which the sensor units 10 are worn are determined in advance). Therefore, the information terminal 20 can accurately perform evaluation of a movement of the user 2 based on a movement of the teacher.

### 2. Modifications

The invention is not limited to this embodiment. Various modified implementations are possible within the range of the gist of the invention.

### 2-1. Functions of the Server

The server 30 in the embodiment explained above may analyze dance analysis data of a plurality of users for each of musical pieces to thereby generate information beneficial for dance practice or the like performed in a group and present the information to at least a part of the plurality of users.

The server 30 in the embodiment downloads and distributes the dance analysis data to the information terminal. However, the server 30 may perform streaming distribution of the dance analysis data.

The server 30 in the embodiment may charge (impose a payment duty for a usage fee on) the user who downloads the dance analysis data or performs streaming reproduction of the dance analysis data. Note that the charging may be performed every time the number of times of the download or the number of tines of the streaming reproduction reaches a predetermined number or may be performed in every fixed period during a contract.

An operator may pay a usage fee of an amount corresponding to the number of times of the download or the number of times of the streaming reproduction to a user who makes dance analysis data of the user public.

In this embodiment, when the dance analysis data is downloaded to or viewed on the information terminal 20, the dance analysis data is downloaded or viewed through the server. However, the dance analysis data may be directly transmitted and received, for example, between information terminals not through the server.

### 2-2. Human Figure Model

The moving image data included in the dance analysis data may be actually-photographed moving image data obtained by photographing a movement of an existing user or may be a CG animation including a virtual user (a human figure model). Instead of the human figure model, a character, an avatar, or the like may be used. A function of processing for converting moving image data of the existing user into moving image data of the virtual user may be mounted on at least one of the information terminal 20 and the server 30.

### 2-3. Sensor Wearing

In the embodiment explained above, the ten parts are assumed as the parts on which the sensor units 10 are worn. However, other parts such as the shoulders of the user 2, the chest of the user 2, the stomach of the user 2, the buttocks of the user 2, and the fingertips of the user 2 may be added to the assumed parts. A part of the assumed parts may be omitted.

In the embodiment explained above, the parts of the body of the user 2 are assumed as the parts on which the sensor units 10 are worn. However, clothes (pockets, a cap, globes, socks, ear covers, etc.) of the user 2, accessories (a necklace, a bracelet, anklets, rings, earrings, a headband, headphones, earphones, etc.) of the user 2, and tools (a club, a hoop, a ball, a ribbon, a stick, a button, etc.) of the user 2 may be assumed.

The shape of the wearing fixtures may be another shape (a table shape or a sheet shape) or the like rather than the belt shape or the tape shape. The sensor unit 10 may be housed in a packet or the like provided in clothes, may be gripped by the user 2, or may be incorporated in a tool, clothes, or an accessory in advance instead of being worn on the body of the user 2 using the wearing fixtures.

In the embodiment, the sensor units are colored. At least one uncolored sensor unit may be used. That is, it is also possible to color all the sensor units in the same color and not use colors for identification of the parts on which the sensor units are worn. A color of a part of the sensor units may be an achromatic color (or a non-luminescent color). Colors of any two or more sensor units may be the same color. Incidentally, when one sensor unit is colored in the achromatic color (or the non-luminescent color), as in the embodiment explained above, it is possible to identify the parts on which the plurality of sensor units are worn.

### 2-4. Calibration

In the calibration, the information terminal 20 displays the human figure guide frame on the display section 25. However, an image at the time when the user, who is the teacher, performs the calibration (an image of the body of the teacher) may be used instead of the guide frame.

The information terminal 20 may adjust, according to body information of the user 2, the size of the human figure guide frame displayed on the display section 25.

### 2-5. Sensor Non-Wearing Part

In the embodiment, for example, when the number of the sensor units 10 owned by the user 2 is small, depending on a part of the body of the user 2, it is likely that deviation from the same part of the teacher cannot be detected.

Therefore, the processing section 21 of the information terminal 20 in the embodiment may calculate deviation of a part on which the sensor unit 10 is not worn in the body of the user 2 according to an interpolation operation based on measurement data of the other parts or deviations of the other parts.

The processing section 21 of the information terminal 20 in the embodiment may use, for the interpolation operation, image processing based on the live video of the user 2 and the moving image of the teacher.

The processing section 21 of the information terminal 20 in the embodiment may improve deviation calculation accuracy by combining the image processing with calculation of deviations of parts on which the sensor units 10 are worn.

### 2-6. Feedback

When deviations of a plurality of parts different from one another exceed the threshold at the same timing, the processing section 21 of the information terminal 20 in the embodiment may perform notification (feedback) to the user 2 concerning all of the plurality of parts but may limit the notification (the feedback) to only a part having the largest deviation. Consequently, the user 2 can perform dance practice while concentrating on a movement of a part that has marked deviation.

2-7. Customizing of a screen

The processing section 21 of the information terminal 20 in the embodiment displays the moving image of the user 2 and the moving image of the teacher to be arranged side by side with each other or superimposed one on top of the other during the reproduction of the musical piece. However, the processing section 21 may cause the user 2 to set (select), in advance, a display position relation between the moving image of the user 2 and the moving image of the teacher. The processing section 21 may cause the user 2 to select, in advance, not to display one of the moving image of the user 2 and the moving image of the teacher.

The processing section 21 of the information terminal 20 in the embodiment may be capable of switching the direction of one of the moving image of the user 2 and the moving image of the teacher between a direction viewed from the front and a direction viewed from the back. The processing section 21 of the information terminal 20 in the embodiment may cause the user 2 to perform the switching.

### 2-8. Other Notification Forms

The processing section 21 in the embodiment can use various forms as a form for notifying the user 2 of any information. As the form for notifying the information, for example, at least one of an image, light, sound, vibration, a changing pattern of the image, a changing pattern of the light, a changing pattern of the sound, and a changing pattern of the vibration can be used.

### 2-9. Other Input Forms

In the processing section 21 in the embodiment, the input of one or a plurality of kinds of information from the user 2 is mainly performed by the touch of the finger (the tap operation on the touch panel or the button operation). However, as the form of the input of one or a plurality of kinds of information, various forms can be used. As the form of the information input, for example, at least one of input by a contact of a finger, input by voice, and input by a gesture can be used.

The processing section 21 in the embodiment can use, for example, a gesture for drawing a circle clockwise with the right hand wearing the sensor unit 10 as a reproduction start instruction and can use, for example, a gesture for drawing a circle counterclockwise with the left hand wearing the sensor unit 10 as a reproduction end instruction.

### 2-10. Modification of the Display Section

In the embodiment, as a section on which one or a plurality of images are displayed, for example, a list-type display section or a head-mounted display section (Head Mounted Display (HMD)) can also be used. The head mounted display is a display that is worn on the head of the user 2 and displays an image on one or both of the eyes of the user 2.

### 2-11. Other Fields

In the embodiment, the example is explained in which a motion of a dance by an individual is analyzed. However, the invention is effective for various motion analyses of a dance by a group, a march, cheerleading, ground practice of synchronized swimming, and movements of a group in a live show venue.

### 2-12. Others

In the embodiment, a part or all of the functions of the sensor unit 10 may be mounted on the information terminal 20 or the server 30. A part or all of the functions of the information terminal 20 may be mounted on the sensor unit 10 or the server 30. A part or all of the functions of the server 30 may be mounted on the information terminal 20 or the sensor unit 10.

In the embodiment, the acceleration sensor and the angular velocity sensor are incorporated in the sensor unit 10 and integrated. However, the acceleration sensor and the angular velocity sensor do not have to be integrated. Alternatively, the acceleration sensor and the angular velocity sensor may be directly worn on the user 2 without being incorporated in the sensor unit 10. In the embodiment, the sensor unit 10 and the information terminal 20 are separate. However, the sensor unit 10 and the information terminal 20 may be integrated to be capable of being worn on the user 2. The sensor unit 10 may include a part of the components of the information terminal 20 together with an inertial sensor (e.g., the acceleration sensor or the angular velocity sensor).

The embodiment and the modifications explained above are examples. The invention is not limited to the embodiment and the modifications. For example, the embodiment and the modifications can be combined as appropriate.

The invention includes a configuration substantially the same as the configuration explained in the embodiment (e.g., a configuration having a function, a method, and a result same as those of the configuration explained in the embodiment or a configuration having a purpose and an effect same as those of the configuration explained in the embodiment). The invention includes a configuration in which unessential portions of the configuration explained in the embodiment are replaced. The invention includes a configuration that realizes action and effect same as the action and the effect of the configuration explained in the embodiment of a configuration that can achieve a purpose same as the purpose of the configuration explained in the embodiment. The invention includes a configuration obtained by adding publicly-known techniques to the configuration explained in the embodiment.

What is claimed is:

1. An information terminal comprising:
a reception processing section configured to receive, via a network, sensing data of a motion of a teacher and moving image data of the motion of the teacher associated with the sensing data of the motion of the teacher;
a presentation processing section configured to present the moving image data of the motion of the teacher to a user;
an evaluating section configured to perform, when the moving image data of the motion of the teacher is presented, an evaluation of a motion of the user using sensing data of the motion of the user and the sensing data of the motion of the teacher; and
a notification processing section configured to notify the user of a result of the evaluation when the moving image data is presented.

2. The information terminal according to claim 1, wherein the sensing data of the motion of the user is generated using two or more sensors worn on parts of a body of the user different from one another.

3. The information terminal according to claim 2, wherein the sensing data of the motion of the teacher is generated using two or more sensors worn on parts of a body of the teacher different from one another.

4. The information terminal according to claim 3, further comprising an image pickup section configured to acquire moving image data of the motion of the user, wherein
the presentation processing section presents the moving image data of the motion of the user together with the moving image data of the motion of the teacher.

5. The information terminal according to claim 4, wherein the presentation processing section presents the moving image data of the motion of the teacher and the moving image data of the motion of the user side by side with each other or one on top of the other.

6. The information terminal according to claim 4, wherein the moving image data of the motion of the user includes information concerning colors different from one another respectively corresponding to the two or more sensors worn on the user.

7. The information terminal according to claim 4, wherein the moving image data of the motion of the teacher includes information concerning colors different from one another respectively corresponding to the two or more sensors worn on the teacher.

8. The information terminal according to claim 4, further comprising a transmitting section configured to transmit the sensing data of the motion of the user and the moving image data of the motion of the user in association with each other via the network.

9. The information terminal according to claim 1, wherein the teacher is a user different from the user.

10. The information terminal according to claim 1, wherein information concerning sound is added to the moving image data of the motion of the teacher.

11. The information terminal according to claim 1, wherein the sensing data includes an output of at least one of an acceleration sensor and an angular velocity sensor.

12. A motion evaluating system comprising:
a sensor configured to sense a motion of a user; and
an information terminal including:
a reception processing section configured to receive, via a network, sensing data of a motion of a teacher and moving image data of the motion of the teacher associated with the sensing data of the motion of the teacher;
a presentation processing section configured to present the moving image data of the motion of the teacher to the user;
an evaluating section configured to perform, when the moving image data of the motion of the teacher is presented, an evaluation of a motion of the user using sensing data of the motion of the user generated using the sensor and the sensing data of the motion of the teacher; and
a notification processing section configured to notify the user of a result of the evaluation when the moving image data is presented.

13. A motion evaluating method comprising:
receiving, via a network, sensing data of a motion of a teacher and moving image data of the motion of the teacher associated with the sensing data of the motion of the teacher;
presenting the moving image data of the motion of the teacher to a user;
performing, when the moving image data of the motion of the teacher is presented, an evaluation of a motion of the user using sensing data of the motion of the user and the sensing data of the motion of the teacher; and
notifying the user of a result of the evaluation when the moving image data is presented.

14. The motion evaluating method according to claim 13, wherein the sensing data of the motion of the user is generated using two or more sensors worn on parts of a body of the user different from one another.

15. The motion evaluating method according to claim 14, wherein the sensing data of the motion of the teacher is generated using two or more sensors worn on parts of a body of the teacher different from one another.

16. The motion evaluating method according to claim 15, further comprising acquiring moving image data of the motion of the user, wherein
the moving image data of the motion of the user is presented together with the moving image data of the motion of the teacher.

17. The motion evaluating method according to claim 16, wherein the moving image data of the motion of the teacher and the moving image data of the motion of the user are presented side by side with each other or one on top of the other.

18. The motion evaluating method according to claim 16, wherein the moving image data of the motion of the user includes information concerning colors different from one another respectively corresponding to the two or more sensors worn on the user.

19. The motion evaluating method according to claim 16, wherein the moving image data of the motion of the teacher includes information concerning colors different from one another respectively corresponding to the two or more sensors worn on the teacher.

20. The motion evaluating method according to claim 16, further comprising transmitting the sensing data of the motion of the user and the moving image data of the motion of the user in association with each other via the network.

21. The motion evaluating method according to claim 13, wherein the teacher is a user different from the user.

22. The motion evaluating method according to claim 13, wherein information concerning sound is added to the moving image data of the motion of the teacher.

23. The motion evaluating method according to claim 13, wherein the sensing data includes an output of at least one of an acceleration sensor and an angular velocity sensor.

24. A recording medium having recorded therein a motion evaluating program for causing a computer to execute:
receiving, via a network, sensing data of a motion of a teacher and moving image data of the motion of the teacher associated with the sensing data of the motion of the teacher;
presenting the moving image data of the motion of the teacher to a user;
performing, when the moving image data of the motion of the teacher is presented, an evaluation of a motion of the user using sensing data of the motion of the user and the sensing data of the motion of the teacher; and
notifying the user of a result of the evaluation when the moving image data is presented.
